(19) United States
(12) Patent Application Publication
(10) Pub. No.: US 2025/0391998 A1
(43) Pub. Date: Dec. 25, 2025

(54) CATHODE AND SEPARATOR FOR LI-S BATTERY

(71) Applicant: NORWEGIAN UNIVERSITY OF SCIENCE AND TECHNOLOGY (NTNU), Trondheim (NO)

(72) Inventors: Liyuan DENG, Trondheim (NO); Saravanan JANAKIRAM, Trondheim (NO); Rameez RAZAQ, Trondheim (NO); Sigrid Steinsli AUSTAD, Trondheim (NO)

(21) Appl. No.: 19/316,789

(22) Filed: Sep. 2, 2025

Related U.S. Application Data
(63) Continuation-in-part of application No. PCT/EP2024/055498, filed on Mar. 1, 2024.
(63) Continuation-in-part of application No. PCT/EP2024/055500, filed on Mar. 1, 2024.

(30) Foreign Application Priority Data
Mar. 2, 2023 (GB) 2303107.3
Jul. 4, 2023 (GB) 2310247.8

(51) Int. Cl. H01M 50/411; H01M 4/38; H01M 4/60; H01M 10/052; H01M 50/403; H01M 50/417; H01M 50/449; H01M 50/489

(52) U.S. Cl. CPC H01M 50/411; H01M 4/382; H01M 4/60; H01M 10/052; H01M 50/403; H01M 50/417; H01M 50/449; H01M 50/489

(57) ABSTRACT

A lithium sulphur battery comprising a Li anode, a separator between the anode and cathode, a Li-containing electrolyte; and a sulphur-containing cathode; wherein the separator comprises a porous substrate carrying a metal-organic framework comprising at least two different metal ions one of which is an iron ion. Also, a process for the preparation of a cathode material for a Li—S battery comprising nucleating metal ions on a graphene oxide or reduced graphene oxide sheet such that the metal ions are chemically bound to the basal plane of the graphene oxide or reduced graphene oxide sheet; growing a metal-organic framework comprising said chemically bound metal ions by adding a polyfunctional ligand to form a metal organic framework bound to a reduced graphene oxide sheet (MOF@rGO); and infusing elemental sulphur into the metal organic framework to form S-MOF@rGO.

### CROSS REFERENCE TO RELATED APPLICATIONS

This application is a continuation-in-part of International Application Nos. PCT/EP2024/055498, filed Mar. 1, 2024, which claims the benefit of priority to GB 2303107.3, filed Mar. 2, 2023, and GB 2310247.8, filed Jul. 4, 2023, and this application is also a continuation-in-part of PCT/EP2024/055500, filed Mar. 1, 2024, which claims the benefit of priority to GB 2303107.3, filed Mar. 2, 2023, and GB 2310247.8, filed Jul. 4, 2023, which are each incorporated by reference herein in their entireties.

### FIELD

This invention relates to a bimetallic metal-organic framework (MOF) supported on a porous substrate which can be used as a separator in a Li—S battery. The invention details a process for the preparation of the required separator and covers Li—S batteries using the separator. These batteries have remarkable performance, in particular in terms of retention of battery charge after repeated recharging.

This invention also relates to the use of a sulphur-infused metal-organic framework bound to reduced graphene oxide in the cathode of a lithium-sulphur battery. The invention details a process for the preparation of a of sulphur-infused metal-organic framework bound to reduced graphene oxide and covers a cathode comprising the sulphur-infused metal-organic framework bound to reduced graphene oxide and batteries comprising the cathode. Batteries using the cathode of the invention have remarkable performance, in particular in terms of retention of battery charge after repeated recharging.

### BACKGROUND

The ever-increasing dependence on portable/rechargeable energy sources and the urgent need for energy storage for renewable energy and the green transition have triggered a rapid development in battery technologies with long life, high-energy density, materials sustainability, and safety. In the field of rechargeable batteries, Li-ion batteries (LiBs) dominate the markets for portable consumer electronics and electric mobility and are making inroads in the industry- and utility-scale energy storage market. LiBs are positioned to play a central role in achieving the European Green Deal of no net emission of greenhouse gases by 2050, particularly in the transport, marine, and grid support applications. However, after more than three decades of development, the current LiBs technology is approaching a fundamental limit in terms of energy density, safety, and cost. For electric vehicle (EV) applications, for example, there is still an urgent demand to further upgrade the energy density to improve the driving range to at least 1000 km. Hence, there is a tremendous effort to develop battery technologies that could offer high energy density.

Li—S battery is considered a ground-breaking technology because they possess 5 times LiBs' theoretical specific capacity (1675 mAh g⁻¹) with high specific energy (2600 Wh kg⁻¹).

A lithium-sulphur battery (Li—S battery) is a type of rechargeable battery. The low atomic weight of lithium and moderate atomic weight of sulphur means that Li—S batteries are relatively light and therefore have attractive properties in environments where light weight is key. The fact that these batteries employ sulphur in the cathode as opposed to metals such as cobalt, a common element in lithium-ion batteries, also makes these batteries economically attractive. Chemical processes in the Li—S cell include lithium dissolution from the anode surface (and incorporation into alkali metal polysulfide salts) during discharge and reverse lithium plating to the anode while charging.

Lithium metal is used as the anode in a Li—S battery. At the anodic surface, dissolution of the metallic lithium occurs, with the production of electrons and lithium ions during discharge and electrodeposition during the charge phase. The half-reaction is expressed as:

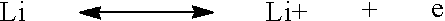

Like lithium batteries, the dissolution/electrodeposition reaction causes problems of unstable growth of the solid-electrolyte interface (SEI), generating active sites for the nucleation and dendritic growth of lithium. Dendritic growth is responsible for the internal short circuit in lithium batteries and leads to the death of the battery itself.

In Li—S batteries, energy is stored in the sulfur cathode. During discharge, the lithium ions in the electrolyte migrate to the cathode where the sulphur is reduced to lithium sulphide (Li₂S). The sulfur is reoxidized to S₈ during the recharge phase. The semi-reaction is therefore expressed as:

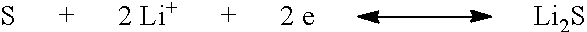

Actually, the sulphur reduction reaction to lithium sulphide is much more complex and involves the formation of lithium polysulphides (Li₂Sₓ, 2≤x≤8).

The final product during discharge is actually a mixture of Li₂S₂ and Li₂S rather than pure Li₂S, due to the slow reduction kinetics at Li₂S. This contrasts with conventional lithium-ion cells, where the lithium ions are intercalated in the anode and cathodes. Each sulphur atom can host two lithium ions. Typically, lithium-ion batteries accommodate only 0.5-0.7 lithium ions per host atom.

In addition to the high energy density, Li—S batteries offer many intrinsic advantages compared with the current LiBs, including
i) improved safety characteristics due to “conversion reaction,” which forms new materials during charge and discharge;
ii) lightweight due to the use of sulfur and carbon instead of heavy metal oxides, thus a greater gravimetric energy density than LiBs. Lighter batteries are a significant advantage for applications such as wearable devices, vehicles, medical devices, drones, and aircraft;
iii) a significantly reduced raw material cost. The cost of sulfur is 0.22 $ kg⁻¹, less than 1% of that of lithium cobalt oxide (the material predominantly used in the cathodes of LiBs);
iv) higher charge rate capacity: recharging faster due to their chemical design; and
v) low battery failure risk, as highly reactive Li anode is passivated with sulfide materials during operation.

However, despite all the advantages, Li—S battery technology is not yet being fully commercialized due to the following critical challenges:
i) the insulating nature of sulfur and Lithium sulfide resulting in poor utilization of sulfur, making it difficult to reach the theoretical capacity;
ii) Polysulfide “shuttle effect,” i.e., the migration of the dissolved intermediates polysulfides (i.e., Li₂S₈, Li₂S₆, and Li₂S₄) through the separator which are reduced on the anode, resulting in loss of capacity and active materials;
iii) Lithium dendrite formation due to uneven transport of Li+ through the separator during battery cycling, causing short circuit in Li—S battery; and
iv) the degradation of cathode due to the loss of active sulfur through charge/discharge.

The main challenges of Li—S batteries are the low conductivity of sulfur and its considerable volume change upon discharging. Hence finding a suitable cathode material is challenging. Many solutions involve a carbon/sulphur cathode and a lithium anode. Sulphur is very cheap, but has practically no electroconductivity so a carbon coating provides the missing electroconductivity.

One problem with the Li—S cathode design is that when the sulphur in the cathode absorbs lithium, volume expansion of the LiₓS compositions occurs, and predicted volume expansion of Li₂S is nearly 80% of the volume of the original sulphur. This causes large mechanical stresses on the cathode, which is a major cause of rapid degradation. This expansion process also reduces the contact between the carbon and the sulphur, and prevents the flow of lithium ions to the carbon surface.

Great efforts have been devoted to addressing these issues. For example, a large number of conductive matrix materials have been designed to optimize the cathode for good conductivity and confine sulfur to prevent the cathode expansion during charging and discharging. Studies to apply different coating materials on separators based on polar surfaces between polar lithium polysulfides (LiPSs) and polar host materials, surface chemistry for polysulfide grafting and catenation, and metal-sulfur bonding, have also been reported. However, these conventional coated materials and sulfur hosts could not stop the migration of soluble polysulfides from the cathode toward the anode, and the cathode materials are still suffering from low electronic conductivity and sulfur loading. Most critically, the cyclic stability obtained to date has still been far from satisfactory because of the volume change and the loss of the active mass of the cathode during charge/discharge cycling.

Another significant problem with Li—S cells is unwanted reactions with the electrolyte. While S and Li₂S are relatively insoluble in most electrolytes, many intermediate polysulfides are not. The dissolution of Li₂Sn (where n is more than 2) into the electrolyte causes irreversible loss of active sulfur from the cathode and again severely limits the life of the battery.

This phenomenon is known as the polysulfide “shuttle”. Historically, the “shuttle” effect is the main cause of degradation in a Li—S battery. The lithium polysulfide Li₂Sx (6≤x≤8) is highly soluble in the common electrolytes used for Li—S batteries. They are formed during battery discharge and leak from the cathode and diffuse to the anode, where they are reduced to short-chain polysulfides and diffuse back to the cathode where long-chain polysulfides are formed again. This process results in the continuous leakage of active material from the cathode, lithium corrosion, low coulombic efficiency and low battery life. Moreover, the “shuttle” effect is responsible for the characteristic self-discharge of Li—S batteries, because of slow dissolution of polysulfide, which occurs also in the rest state. The electrolyte plays a key role in Li—S batteries, acting both on the “shuttle” effect by the polysulfide dissolution and the SEI stabilization at the anode surface.

Conventionally, Li—S batteries employ a liquid organic electrolyte, contained in the pores of a polypropylene separator that separates the anode and cathode. The electrolyte plays a key role in Li—S batteries, acting both on the “shuttle” effect by the polysulfide dissolution and the SEI stabilization at anode surface.

These separators offer no help in addressing the polysulphide shuttle, however.

Many researchers have therefore used various MOFs in modified separators in Li—S batteries. US2020/0220136 exemplifies a UiO-66 MOF using Zr ions on a polymeric carrier. The use of a bimetallic material is not exemplified.

CN113410575 also describes a MOF that is adhered to a carrier to form a diaphragm for an Li—S battery. FJU-88 or FJU-90 MOFs are suggested using a Co metal ion.

However, blocking polysulfides by the specific pore size of MOF material alone is not sufficient to control the flood of the polysulfides for a long period of time. In this regard, introducing a 2nd active metal site as an electrocatalyst is crucially important to enable electro-catalytic conversion of blocked or adsorbed polysulfides into active materials.

CN107681091 describes a bimetallic separator based on a BMZIF-5 using Zn and Co ions but which is calcined to carbonize the material. The carbonized material is mixed with PVDF to create the coating for the diaphragm. The lithium-sulfur battery functionalized composite membrane is therefore characterized in that it comprises a membrane substrate and a nitrogen-cobalt-doped graphitized carbon material and binder. Such a material is, however, cumbersome and costly to produce. It would be advantageous if the MOF did not need to be carbonized. From a sustainability point of view, calcination of the MOF requires high temperatures (˜1000° C.) and an expensive gas (such as Ar or hydrogen) for long periods of time which not only makes the material expensive but also creates environmental hazards. Furthermore, by heating at high temperatures, MOF materials lose their inherent porosity and the MOF structure, which actually helps in sieving the polysulfides and Li-ions, is degraded.

J. Energy Chem, vol 82, 2023, Xiaolong ET AL describes bimetallic Ni—Co MOF@PAN modified, electrospun battery separators. In Chinese Chem. Letters vol 34, 2022, Pingli et also describe bimetallic Ni—Co MOF with CNTs for battery separators.

### First Embodiment

The present inventors have found that an effective solution to many of the above challenges is to apply super-selective separators that can block the dissolved polysulfide while allowing the permeation of Li+ ions. Carefully designed separators can, inter alia, therefore alleviate the polysulfide shuttling and lithium dendrite formation problems.

The present inventors have established that a cost-effective bimetallic MOF separator can be prepared, which selectively blocks and converts the dissolved polysulfides while sieving Li+ ions in Li—S batteries. Remarkably higher catalytic activity was observed for the conversion of polysulfides by the Fe-doped ZIF-8 and Fe-doped NH₂UIO66 of the invention compared to the parent ZIF-8 and NH₂UIO66. Meanwhile, the incorporation of Fe (II) ions into the ZIF framework dramatically improved the specific capacity and rate capability. The Li—S battery using Fe—ZIF-8/PP separator exemplified herein displays high cycle life of 1000 cycles and exhibits a high initial capacity of 863 mAh g⁻¹ at 0.5 C and 746 mAh g⁻¹ at 3 C. Li—S batteries of the invention with bimetallic MOF-modified separators have high capacity and long cyclic life even at high current rate. Furthermore, the Fe—ZIF-8/PP separator delivers desirable sulfur electrochemistry even under the relevant conditions of high sulfur loading and lean electrolyte while a Li∥Li symmetrical cell with this Fe—ZIF-8/PP separator exhibited outstanding cycling performance at a high current density of up to 10 mA cm⁻².

The use of Fe as one of the metals in the bimetallic MOF offers various further benefits. Iron is abundant and cheap making bimetallic MOFs using iron economically attractive. Iron is also safe with limited environmental concerns.

Iron is non-toxic and does not pose a significant health risk unlike many other metals which can be harmful to humans and the environment when recycled.

### Second Embodiment

The present inventors have also identified a novel cathode material for Li—S batteries, in which the cathode comprises a graphene derivative e.g. partially reduced graphene oxide or reduced graphene oxide. This material provides therefore conductivity to the cathode. The graphene derivative is functionalized by growth thereon of a metal-organic framework (MOF) into which can be infused sulphur. Importantly, the sulphur infused into the pores of the metal-organic framework is constrained by the framework and cannot escape from the cathode during charging and discharging cycles. As noted above, when the sulphur reacts with Li during battery operation, lithium polysulphides are produced that are much larger than the elemental sulphur. These compounds are however too big to escape the pores of the metal-organic framework and hence cathode degradation can be severely curtailed and the polysulphide shuttle effect significantly reduced. The 2D graphene based nanosheets with spaces between the basal planes accommodate volumetric expansion of sulphur derivatives during the charging and discharging process.

It has been surprisingly found that cathodes comprising a Metal-Organic Framework (MOF) grown on a 2-dimensional graphene oxide derivative (called GO herein) which may be partially reduced or completely reduced in use (called rGO herein) offer attractive properties for Li—S batteries. These MOF@rGO containing cathodes can be made into flexible and foldable batteries with very high capacity with potentially advantageous size, safety and efficiency.

MOFs have been considered in Li—S batteries before. CN110492088 discloses a ZIF-8@reduced graphene oxide loaded sulfur composite material in the context of a Li—S battery positive electrode. ZIF-8 composed of Zn ions and imidazolate ligands. The cathode is prepared by first reducing the graphene oxide, then, under the action of zinc salt and urea, synthesizing ZIF-8 in situ on the surface of the reduced graphene oxide.

Chemical Engineering Journal, vol. 450, 4, 2022, S. Qiu et al., “Tunable MOFs derivatives for stable and fast sulfur electrodes in Li—S batteries” discusses tunable MOF derivatives for stable and fast sulphur electrodes in Li—S batteries. MOFs are not however anchored to graphene therein.

WO2022/020631 describes sulphur loaded MOF mixed with graphene flakes and a polymer residue to form a composite. The MOF is not however bound to the graphene.

CN11241133 describes a graphene/MOF framework obtained by simply blending of the materials. In Example 1, the MOF is pre-synthesised and combined with the graphene.

CN109301191 also discloses graphene/MOF materials but the MOF is prepared separately and combined with the graphene oxide. These are therefore physical blends of the components.

In CN111653729 graphene acts as a carrier in a layered electrode in which sulphur is applied on the graphene followed by the MOF.

CN109950487 aims to provide a Li—S battery positive electrode material with high specific capacity. The invention requires the growth of a metal organic framework ZIF-67 on a graphene sheet by a simple hydrothermal method to form a composite material as the Li—S battery positive electrode material.

In the prior art therefore, the graphene oxide derivative and MOF or the graphene derivative and synthetic precursors to the MOF are simply mixed. The present inventors have appreciated that this method for growing the MOF does need lead to optimum performance.

The present inventors have designed a facile method to efficiently utilize the GO functional groups to obtain dense, ordered, and uniformly sized MOF nanoparticles on rGO.

In the present case, there is a careful pretreatment step of the GO to make sure that MOF is eventually bound to the graphene oxide basal planes by growing onto the metal nucleation sites. Where the Metal-Organic Framework is bound to the 2-dimensional Graphene derivative (graphene oxide, partially reduced graphene oxide and reduced graphene oxide), the cathode performance was enhanced. This material was tested as a cathode in Li—S batteries, exhibiting sustainably, enhanced cycling stability and a lower capacity-fading rate even after >3000 cycles.

The method of the invention and the cathodes of the invention overcome critical problems existing in the current Li—S batteries thanks to the cathode's high affinity towards lithium polysulfides adsorption and catalytic conversion in Li—S batteries.

Compared with reported cathode materials prepared by simply mixing MOFs and rGO, in this invention, MOFs are chemically coordinated to graphene basal planes. This key innovation enables the significantly improved capacity, performance, and stability of the battery. Such functional cathode materials can be regarded as the first in the market to improve battery performance in terms of ultra-long cyclic life with less capacity decay. In particular, Li—S batteries of the invention with S-MOF@rGO cathodes under the conditions of high areal sulfur loading of 0.1-9 mg cm⁻² and electrolyte to sulphur ratio (E/S=5-50 μL/mg of S), delivered promising specific capacity.

### SUMMARY

Viewed from one aspect, the invention provides a lithium sulphur battery comprising:
(i) a Li anode,
(ii) a separator between the anode and cathode,
(iii) a Li-containing electrolyte; and
(iv) a sulphur-containing cathode;
wherein the separator comprises a porous substrate carrying a metal-organic framework comprising at least two different metal ions one of which is an iron ion.

Viewed from another aspect, the invention provides a lithium sulphur battery comprising:
(i) a Li anode,
(ii) a separator between the anode and cathode,
(iii) a Li-containing electrolyte; and
(iv) a sulphur-containing cathode;
wherein the separator comprises a porous substrate carrying a non-carbonised metal-organic framework comprising at least two different metal ions.

Viewed from another aspect the invention provides a lithium sulphur battery comprising:
(i) a Li anode,
(ii) a separator between the anode and cathode,
(iii) a Li-containing electrolyte; and
(iv) a sulphur-containing cathode;
wherein the separator comprises a porous substrate carrying a metal-organic framework comprising at least two different metal ions wherein said metal-organic framework is a zeolitic imidazolate framework.

Viewed from another aspect, the invention provides a separator suitable for use in a battery such as a lithium sulphur battery comprising a substrate, said substrate having deposited thereon a metal-organic framework comprising at least two different metal ions one of which is iron.

Viewed from another aspect, the invention provides a process for the preparation of separator as hereinbefore defined comprising:
1) dissolving two metal salts in a solvent in the presence of an imidazole type ligand or tri or dicarboxylic acid such as 1,4-benzenedicarboxylic acid and mixing in order to allow formation of a precipitate which comprises a metal-organic framework comprising at least two different metal ions one of which is an iron ion;
2) separating the precipitate and forming a slurry therewith and coating the same onto a porous substrate.

Viewed from another aspect, the invention also provides a process for the preparation of a cathode material for a Li—S battery, said process comprising:
(i) nucleating metal ions on a graphene oxide or reduced graphene oxide sheet such that the metal ions are chemically bound to the basal plane of the graphene oxide or reduced graphene oxide sheet;
(ii) subsequently, growing a metal-organic framework comprising said chemically bound metal ions by adding to the product of step (i) a polyfunctional ligand and optionally heating the resulting mixture to a temperature of at least 20° C., such as 100 to 250° C. so as to form a metal organic framework bound to a reduced graphene oxide sheet (MOF@rGO);
(iii) infusing elemental sulphur into the metal organic framework to form S-MOF@rGO such that the weight of sulphur based on the weight of the S-MOF@rGO is 50% to 90%.

Viewed from another aspect, the invention provides a process for the preparation of a cathode material for a Li—S battery, said process comprising:
(i) nucleating metal ions on a graphene oxide sheet such that the metal ions are chemically bound to the basal plane of the graphene oxide sheet;
(ii) subsequently, growing a metal-organic framework comprising said chemically bound metal ions by adding to the product of step (i) a polyfunctional ligand and heating the resulting mixture to a temperature of at least 20° C., such as 100 to 250° C. so as to form a metal organic framework bound to a reduced graphene oxide sheet (MOF@rGO);
(iii) infusing elemental sulphur into the metal organic framework to form S-MOF@rGO such that the weight of sulphur based on the weight of the S-MOF@rGO is 50% to 90%.

Viewed from another aspect, the invention provides a cathode for a Li—S battery comprising a reduced graphene oxide sheet chemically bound via the basal plane of said reduced graphene oxide to a metal-organic framework via an oxygen-metal linker, said metal organic framework being infused with sulphur to form a structure S-MOF@rGO wherein the weight of sulphur based on the weight of the S-MOF@GO is 50% to 90%. Preferably, at least 50 wt % of the MOF present is bound to the reduced graphene oxide sheet.

Viewed from another aspect, the invention provides a Li—S battery comprising:
(i) a Li anode,
(ii) a separator between the anode and cathode,
(iii) a Li containing electrolyte; and
(iv) a cathode as hereinbefore defined.

In a preferred embodiment, the separator comprises a bimetallic MOF.

### BRIEF DESCRIPTION OF THE FIGURES

FIG. 1a is a schematic illustration of an electrochemical cell that has a Li anode, a cathode comprising sulfur and carbon black, Celgard 2400 separator, and liquid electrolyte in an Ar-filled glove box. FIG. 1b is a schematic illustration of the functional bimetallic 3D MOF-based separator of example 1 designed specifically for Li—S batteries that selectively blocks and converts polysulfides while providing even transport of Li⁺ ions due to highly ordered micropores with pore sizes of ˜10 Å, which is significantly smaller than the diameters of intermediate chain length lithium polysulfide.

FIGS. 2a and 2b show the SEM images of the Celgard (PP) separator and MOF-coated Celgard separator of example 1. The SEM images of pristine PP contain a porous structure with pores in a wide range of up to several hundreds of nanometers, which allows the penetration of polysulfides dissolved in the electrolyte (FIG. 2a), while the SEM images of the MOF-coated separator clearly show that the separator is fully coated with the MOF (FIG. 2b). This coating provides the pore structures and functionality that blocks polysulfides.

FIGS. 3a-3d depict the digital images of the modified separator demonstrating that the PP separator is fully covered with MOF (FIG. 3a). The MOF-coated separator was twisted twice but it has the ability to hold its initial shape, which implies that MOF is firmly bounded to the separator and possesses high mechanical stability with sufficient flexibility (FIGS. 3c-3d).

FIG. 4 shows the thermal shrinkage test of the Celgard and MOF-coated Celgard separator of example 1 at room temperature and at 150° C. Minimal thermal shrinkage of the separator is required to prevent internal short circuits of batteries at elevated temperatures. As presented in FIG. 4, the commercial Celgard separator shrinks completely at 150° C. Such high thermal shrinkage of the Celgard could result in an increased safety risk during thermal runaways. However, MOF-coated separator shows better thermal resistance capability. Even at 150° C. it retained its original shape.

FIGS. 5a and 5b demonstrate the polysulfide permeation test with a PP separator and MOF-coated PP separator of example 1. High permeation resistance towards soluble polysulfides is critical for modified separators in Li—S batteries. In this regard, the permeation experiment was conducted by using an H-shape cell to examine the polysulfide permeation across the separators (FIGS. 5a, 5b). The polysulfide solution (Li₂S₆) was added to the left side (black) and the blank electrolyte was introduced into the right side of the cell (colourless).

FIG. 6 shows the Li plating/stripping performance in symmetric cells with PP and MOF/PP, separators at different current densities with an areal capacity of 1 mA h cm⁻². Li∥Li symmetric cells were employed to evaluate the polarization effect by using PP, and MOF/PP separators. The Li electrode with the PP separator exhibits a high initial overpotential (72 mV) at a current density of 0.5 mA cm⁻² and an areal capacity of 1 mA h cm⁻². However, Li∥Li symmetric with MOF/PP delivers the minimum polarization (36 mV). Likewise, symmetric cells with the MOF/PP separator also show steady polarization vibrations with increased current densities from 1 to 10 mA cm-2 under an areal capacity of 1 mA h cm⁻². The voltage hysteresis of the symmetrical cell with the PP separator started to increase around 700 h, which is probably due to the growth of Li dendrites and the consumption of electrolytes.

FIG. 7 shows the ultra-long-term cycling performance of a symmetric cell with a MOF/PP separator of example 1 at a current density of 0.5 mA cm⁻² with an areal capacity of 1 mA h cm⁻², which performed stably for more than 4000 h with a low voltage hysteresis.

FIGS. 8a and 8b show the SEM images of Li anodes with PP separator (8a) and MOF-protected PP separator (8b). To reveal the role of Fe—ZIF-8/PP in the Li plating/stripping process, the surface morphologies of the Li plate after 1000 h cycles were examined by SEM. The surface of Li metal with a conventional PP separator presents cluttered Li dendrites (FIG. 8a), but that with the MOF/PP separator still maintains a smooth surface (FIG. 8b), indicating a more effective function of the MOF/PP separator in suppressing the growth of lithium dendrites.

FIG. 9 shows the cyclic voltammetric curves of Li—S batteries with PP and MOF/PP separators under the voltage window of 1.7-2.8 V at a scan rate of 0.1 mV/s. Two distinct reduction peaks I and II were assigned to the conversion of S₈ molecule to high-order soluble polysulfides and their further transformation to Li₂S₂ and Li₂S. The oxidation peaks (Ill and IV) corresponding to the conversion of Li₂S₂ and Li₂S to the sulfur molecule. However, the CV curve of MOF/PP showed two sharp redox peaks, i.e., the significant negative move of the oxidation peak and the positive move of the reduction peak, suggesting the reducing polarization and much better electrocatalysis, while the well-echoed peaks indicate the reversible electrochemical reactions that occurred in the electrode materials.

FIG. 10 shows the rate capability at different current rates (C− rates) for Li—S batteries with PP (lower curve) and MOF/PP (higher curve) separators under the voltage window of 1.7-2.8 V. The battery with the PP separator showed dramatic capacity decay at different C-rates. In contrast, the Li—S battery with MOF-coated separator demonstrated much better performance (1036 mA h g⁻¹ at 0.3 C). On cycling at 0.5 C, 1 C, 2 C, and 3 C, the capacities remained at 903 mAh g⁻¹, 830 mA h g⁻¹, 785 mA h g⁻¹ and 746 mA h g⁻¹, respectively. Finally, the capacity returned to 882 mA h g⁻¹ at 0.5 C, while the capacity decay was merely 0.06% per cycle.

FIG. 11 shows the cyclic performance of the Li—S batteries with PP (lower curve) and MOF/PP (higher curve) separators, S-Carbon cathode, and Li anode into the coin cell described herein. Li—S battery with MOF/PP exhibits 865 mAh g⁻¹ discharge capacity, ending with 409 mAh g⁻¹ after 1000 cycles with a Coulombic efficiency of ˜100%. In contrast, PP showed lower initial capacities (466 mAh g⁻¹), endings with 167 mAh g⁻¹ after 1000 cycles, and Coulombic efficiency of >100%.

FIG. 12 shows the Electrochemical polarization studies for PP, and MOF/PP separators to further confirm the improved conversion of polysulfides. The discharge plateaus of Li—S with MOF/PP are flatter, along with a higher discharge and charge capacity. Moreover, Fe—ZIF-8/PP shows less voltage hysteresis (ΔE=0.16 V) compared with PP (ΔE=0.30 V). In the galvanostatic discharge curves, Q_{H} corresponds to the high discharge plateaus and Q_{L} corresponds to the low discharge plateaus for the conversion reaction of the polysulfides. The Li—S battery with MOF/PP displays the highest specific capacity for Q_{H} and Q_{L} compared with PP cell (Fe—ZIF-8/PP: Q_{H}: 378, Q_{L}: 658; PP: Q_{H}: 344, Q_{L}: 334 mAh g⁻¹). The high discharge capacity values for Q_{H} and Q_{L} confirm the electrocatalytic conversion of the polysulfides improved the utilization of active material.

FIG. 13 represents the Coulombic efficiency (right axis) and discharge capacity (left axis) versus cyclic numbers on the x-axis of S-MOF@rGO (MOF bonded with rGO—upper line) and S-MOF+rGO (MOF non-bonded, i.e. mixed with rGO physically—lower line). The cyclic performance was measured at a current density of 0.5 C. The charge/discharge voltage range was 1.6-2.8 V.

FIG. 14 represents the rate capability of the Li—S battery with S-MOF@rGO cathode at different current densities. The cathode was prepared as described in example 4. The coin cell assembled for rate performance (as described in FIG. 1a) consists of the S-MOF@rGO cathode, Li anode, Celgard separator, and liquid electrolytes (1M lithium bis(trifluoromethanesulphonyl)imide in 1:1 (v/v) 1,3-dioxolane/1,2-dimethoxyethane with lithium nitrate additive). The charge/discharge voltage range was 1.6-2.8 V. At 0.1 C, the initial discharge capacity can reach up to 1246 mAh g⁻¹. On cycling at varied C-rates, namely 0.3 C, 0.5 C, 1 C, 2 C, 4 C, and 8 C the capacities remained at 870 mAh g⁻¹, 764 mAh g⁻¹, 675 mAh g⁻¹, 594 mAh g⁻¹, 455 mAh g⁻¹ and 384 mAh g⁻¹ respectively. When the current density was switched back to 0.5, the capacity reverted to 691 mAh g⁻¹ at the end which is the best reversible capacity at a very high current.

FIG. 15 represents the cyclic performance of the Li—S battery with S-MOF@rGO cathode at 0.1 C. The cathode was prepared as described in example 4. The coin cell assembled for rate performance is as described for FIG. 14. The charge/discharge voltage range was 1.6-2.8 V. Li—S coin cell with S-MOF/rGO cathode delivered an initial discharge capacity of 802 mAh g⁻¹. From the initial cycle to 100 cycles its exhibits a discharge capacity of 394 mAh g⁻¹ with a decay rate of 0.03% per cycle. However, from 100 to 1831 cycles, it delivered a discharge capacity of 264 mAh g⁻¹ with a decay rate of 0.01% per cycle merely.

FIG. 16 represents the cyclic performance of the Li—S battery with S-MOF@rGO cathode at 0.2 C. The cathode was prepared as described in example 4. The coin cell assembled for rate performance is described for FIG. 14. The charge/discharge voltage range was 1.6-2.8 V. Li—S coin cell with S-MOF/rGO cathode delivered a high discharge capacity of 413 mAh g⁻¹. However, after 3817 cycles it delivered a discharge capacity of 159 mAh g⁻¹ with a decay rate of 0.01% per cycle only.

FIG. 17 represents the cyclic performance of the Li—S battery with S-MOF@rGO cathode at 0.1 C with high areal sulfur loading and minimum volume of the electrolyte. For the commercialization of Li—S batteries, addressing the challenge of high sulfur loading is crucially important. To deal with this problem, the areal sulfur loading was increased from 2.4 to 8 mg cm⁻² by fabricating a thick electrode. While the electrolyte-to-sulphur ratio was 6.6 μL per mg of Sulphur. Cathode was prepared as described in example 4 but using a cathode punched into a round shape with a diameter of 14 mm. The coin cell assembled for rate performance was as described in FIG. 14. The charge/discharge voltage range was 1.6-2.8 V. Li—S coin cells with S-MOF/rGO cathode delivered the high discharge capacities of 138 mA h g⁻¹ 215 mA h g⁻¹, 254 mA hg⁻¹, 283 mA hg⁻¹, 321 mA hg⁻¹, 575 mA hg⁻¹ and 603 mA hg⁻¹ at the areal loading of 8 mg cm⁻², 6.3 mg cm⁻², 4.6 mg cm⁻², 4 mg cm⁻², 3.3 mg cm⁻², 3 mg cm⁻² and 2.4 mg cm⁻² respectively.

### DETAILED DESCRIPTION

### Definitions

The abbreviation MOF means metal-organic framework.

The abbreviation GO means graphene oxide. The abbreviation rGO means reduced or partially reduced graphene oxide.

A single-layer graphene sheet has two different structural regions. (1) the basal plane, consisting of two-dimensional conjugated sp2 carbon atoms; (2) the edge, making of one-atom thick defective graphitic line of carbon atoms with dandling bonds and various capping moieties (e.g., hydrogen, hydroxyl, carbonyl and carboxyl groups. The basal plane therefore consists of two-dimensional conjugated sp² carbon atoms.

The abbreviation MOF@rGO is used herein to represent a metal-organic framework bound to a partially reduced or reduced graphene oxide sheet and prepared following the protocols of the invention i.e. such that the MOF is bound to the reduced graphene oxide via the metal ions that are coordinated to the oxygen atoms on the basal planes of the graphene oxide.

### Detailed Description of Invention of First Embodiment

In a first embodiment, this invention relates to a new separator to be used in a battery, especially a Li—S battery. In a Li—S battery, a separator is used to separate electrodes from each other, i.e. the separator separates the anode from the cathode. Conveniently, the anode is in contact with one side of the separator with the cathode in contact with the other side of the separator. The separator typically takes the form of a layer within Li—S battery cell and comprises a substrate layer with a metal-organic framework comprising at least two different metal ions one of which is an iron ion being applied to one or both sides of the substrate. The metal-organic framework comprising at least two different metal ions may be protected by a further inert protecting layer.

Conventionally, separators in Li—S batteries have been made simply from a polymeric porous material such as a polyolefin, e.g. a polyethylene or more preferably a polypropylene. Other polymers used as separators include polyesters, polyolefins, polyamides, polyacrylonitriles, polyimides, polyetherimides, polysulphones, polyamideimides, polyethers, polyphenylenesulphides and aramids, or mixtures of two or more of these polymers. These conventional separators can be used as the substrate in the present invention.

In the present invention, the separator of use in the invention comprises a substrate layer which has deposited thereon a metal-organic framework comprising at least two different metal ions one of which is an iron ion. This will be called a bimetallic MOF herein.

In particular, the separator of use in the invention comprises a porous substrate layer functionalised to carry a bimetallic MOF. The bimetallic MOF used in the separator of the invention is conveniently synthesised separately using conventional techniques and is subsequently coated onto the substrate. The bimetallic MOF can form therefore a thin film on the substrate, e.g. 15 microns or less, such as 7 microns or less in thickness, such as 1.0 to 15 microns, preferably 1.0 to 5.0 micron thick film thereon. The bimetallic MOF may be deposited on one or both sides of the substrate. It is preferred however that the bimetallic MOF layer is present between the cathode and substrate layer.

The porous substrate can be any suitable material but is typically a polymeric substrate such as polyolefin, e.g. polyethylene and polypropylene, polyesters, polyamides, polyacrylonitriles, polyimides, polyetherimides, polysulphones, polyamideimides, polyethers, polyphenylenesulphides and aramids. The use of a polypropylene is preferred as a substrate material. The substrate layer may be 10 to 50 microns in thickness. The polypropylene can be woven or non-woven. In one embodiment, the substrate, such as polypropylene substrate can be non/woven and melt-blown.

The use of a porous polypropylene film or non-woven or melt-blown porous polypropylene fabric is especially preferred.

Moreover, polypropylene can be modified with different polymeric solutions such as Nafion, polysulfone and AF-2400 in order to enhance the porous structure of the substrate for Li—S battery application to meet the common requirements for a battery separator, including high chemical stability in electrolyte and electrode materials, low thickness, and appropriate porosity (˜40%), good wettability, little thermal shrinkage, narrow pore size distribution with pore size smaller than active materials, and good mechanical stability and strength.

The bimetallic MOF is preferably non-carbonised. By non-carbonised is meant that the formed MOF is not subjected to a calcination process to carbonise the organic material therein. A calcination process typically takes place at a temperature of at least 700° C. One benefit of the present case is that the bimetallic MOF that is required can be prepared in a low-temperature process using water only as a solvent as described further below. In the present invention, the MOF is synthesized and the pristine bimetallic MOF is prepared by adding, Fe as a second metal in the parental MOF, such as ZIF-8 which has Zn metal with a unique 3D flower-like morphology. Furthermore, we synthesize bimetallic MOF in water only at a very low temperature (e.g. 35° C.).

The bimetallic MOF of the invention comprises at least two metal ions, one of which is an iron ion such as Fe ion and at least one other 1^{st} row transition metal ion. The use of metal ions in the 2⁺ oxidation state is preferred.

In a preferred embodiment two metals only are used in the manufacture of the bimetallic MOF used in the separator, ideally two 1^{st} row transition metals including Fe, such as Fe and one of Co, Zn, Zr, Mn, and Cr. In particular Fe ions are used with a second 1^{st} row transition metal, especially Zn and Fe ions are used. Alternatively, Cr and Fe ions are used. It is preferred if no Ni ions are present. It is preferred if no Co ions are present

One advantage of using Fe and Zn in combination, especially in combination with a ZIF such as ZIF-8, is cost, safety and environmental impact. Such a combination avoids more toxic metals such as Co and Ni. Co and Ni are also much more challenging to source, increasing costs and posing a potential supply-chain risk.

The ratio of metal ions may be in the molar range of 20:1 to 1:20, such as 10:1 to 1:10, preferably 1:4 to 4:1. If Zn and Fe are used it is preferred if the Zn metal ions are used in molar excess. If Cr and Fe are used it is preferred if the Cr metal ions are used in molar excess, such as Cr or Zn:Fe or 20:1 to 1:1, such as 10:1 to 1:1 or 10:1 to 3:1.

Fe sites act as an efficient electrocatalyst for the adsorption and conversion of polysulfides. The use of Fe (II) is especially preferred. In general, it is preferred if the second metal ion is an electrocatalyst for adsorption and conversion of polysulfides. The addition therefore of another metal in the MOF to form the so-called bimetallic MOF improves the conversion of polysulfides resulting in high specific discharge capacity.

The MOF preferably forms at least 60 wt % of the weight of bimetallic MOF, such as 75 wt % or more. The metal ions, therefore, form 40 wt % or less, such as 25 wt % or less.

In order to apply the bimetallic MOF to the substrate, it may be that an adhesive has to be used. Any conventional adhesive is suitable as long as it is inert and does not affect the functioning of the battery.

The use of a bimetallic MOF as a coating on a substrate offers advantages as such a separator prevents lithium sulphides from crossing the separator. The metal nodes in the MOF act as anchoring sites for lithium sulphide adsorption. The small pore size and pore window size act as a molecular sieve for Li and polysulphides.

The present invention therefore solves the problem of the polysulphide shuttle as the sulphur within the pores of the MOF is electrochemically attracted to the metal ions and does not readily escape from the pores of the MOF. Moreover, during the battery operation the separator of the present invention encourages the formation of Li₂S₂ and Li₂S rather than soluble sulphides such as Li₂Sx where x is 8, 6, 4 or 3.

Li—S batteries with bimetallic MOF separators as claimed herein deliver specific capacity even at a high current rate. Furthermore, Li—S batteries of the invention exhibit extraordinary capacity retention. This can be achieved using an environmentally benign and cost-effective synthesis using water is the only solvent at merely 35° C.

### Metal-Organic Frameworks for the Separator Embodiment

Metal-Organic Frameworks (MOFs) are porous nanomaterials composed of metal ion clusters linked together by organic ligands into three-dimensional structures. The variety of possible constituents has led to more than 20,000 different MOFs being reported. In between the organic and inorganic building units, cavities with well-defined openings emerge, called pores herein. These pores have a volume (i.e. a pore size) and a pore opening (or pore window) which governs how large a molecule can pass into a pore and pass out of the pore. Depending on the constituents chosen, the pore openings can be as large as 10 nm and the surface area within the pore can be tuned from 1,000 to 10,000 m²/g.

The growth mechanism of MOFs has been widely investigated, and it generally accepted that the MOF forming process happens by nucleation and spreading, where nuclei with surface adsorbed organic ligands aggregate into an inorganic-organic crystal. The formation of MOFs can be described by three steps, where the first is the deprotonation of organic ligands followed by complexation of these deprotonated ligands with metal ions. Secondly, after large collections of these metal-ligand complexes or oligomers are formed, they can coalesce into MOF crystals. Further growth of these particles is caused by diffusion of oligomers to the particle surface. Lastly, growth is terminated, either when the system reaches equilibrium with respect to the solvated species in solution, or by the use of terminal capping agents.

It will be appreciated that as the MOF grows, more metal ions become incorporated into the structure and hence the MOF growth process requires the presence of a metal salt, typically the same as the one used in the coordination step.

Ligands used to grow the MOF are well known and are based on polyfunctional organic ligands such as those comprising carboxyl groups, amine groups and optionally other functional groups. It is preferred if the MOF used in the separator of the invention is prepared using a nitrogen containing ligand. In one embodiment, an imidazole type ligand is used such as a 2-methylimidazole salt. In one embodiment, a polyfunctional organic ligand which comprises at least one carboxyl group, such as a carboxylic acid, is used. Ligands comprising at least two carboxyl groups are preferred. Ligands are generally small molecules having a Mw of up to 300 g/mol.

The use therefore of small molecule tri or dicarboxylic acids is one option such as 1,4-benzenedicarboxylic acid or 1,3,5-benzenetricarboxylic acid. Ligands of interest often contain an aromatic ring such as a phenyl ring. Some ligands might contain both carboxyl and amino groups such as 2-aminoterephthalic acid.

The use of NH₂—UiO-66(Zr) or MIL101(Cr) is one option for the MOF. These can be doped with Fe ions to form the bimetallic MOF required in the invention. The metal ion combination may therefore be Zr/Fe or Cr/Fe.

In one preferred embodiment, the MOF used is a zeolitic imidazolate framework (ZIF). These are a class of metal-organic frameworks (MOFs) that are topologically isomorphic with zeolites. ZIF glasses can be synthesized by the melt-quench method and are composed of tetrahedrally-coordinated transition metal ions (e.g. Fe, Co, Cu, Zn) connected by imidazolate linkers. Since the metal-imidazole-metal angle is similar to the 145° Si—O—Si angle in zeolites, ZIFs have zeolite-like topologies. ZIFs such as ZIF-6, ZIF-7, ZIF-8 and ZIF-L are preferred.

ZIFs are a preferred option herein as they offer excellent chemical stability due to the presence of metal nitrogen bonds in the framework. ZIFs are ideally composed of metal ions or clusters linked together by imidazolate-based ligands. Imidazolate-based ligands offer unique advantages such as versatility, stability, tunable properties, redox activity, and structural diversity over organic ligands of various types, such as carboxylates, sulfonates, or phosphonates.

Moreover, ZIFs often have smaller pore sizes and narrower pore size distributions compared to other MOFs. A small pore size and narrow pore size distribution can help block the polysulphide shuttle effect in Li—S batteries.

In one embodiment, a lithium sulphur battery of the invention uses a separator comprising a porous substrate carrying a metal-organic framework comprising at least two different metal ions wherein said metal-organic framework is a zeolitic imidazolate framework. Whilst it is preferred in this embodiment for one of the metal ions to be Fe, in this embodiment any suitable metal ion combination can be used, such as a combination of 1^{st} row transition metal ions. All embodiments described herein in connection with the use if Fe ions and a second metal ion in any MOF, are applicable to this embodiment of the invention where the MOF is specifically a ZIF.

Hydrothermal and solvothermal approaches are the synthesis techniques most frequently reported for MOF synthesis. In this solution-based method, a solution containing the metal ion precursors and the ligand precursors is placed inside a sealed reaction container which is heated to temperatures around the boiling point for the solvent used. At these elevated temperatures (and optionally pressures from 1 to 200 bars), crystallization of a product occurs.

Another synthesis technique available for MOF synthesis, is ultrasound-assisted synthesis, also referred to as sonochemical synthesis. In this solution-based method, a solution containing the metal ion precursor and the ligand precursor is placed in a sonication bath where it is exposed to high-energy ultrasonic waves for a period of time. The high-energy waves interact with the liquid and create cyclic alternating regions with high and low pressure, which again forms cavities within the liquid. These cavities grow due to diffusion of solute vapor into the cavities caused by the ultrasonic waves until they become unstable and collapse. By then, there has been an accumulation of ultrasonic energy within these cavities, which is rapidly released upon collapse. This leads to local heating and cooling rates up 1000 K/s. These extreme conditions lead to excitation of molecules, molecular bond breakage and formation of radicals which can react further, causing nucleation and growth of MOF nanoparticles. Compared to other MOF synthesis techniques, sonochemical synthesis can be performed at room temperature or at relatively low synthesis temperatures. In addition, more homogeneous products can be obtained due to the dissolution and mixing of the precursors.

In the present invention the hydrothermal method is preferred and hence after the coordination step, it is preferred if a solution of the polyfunctional ligand is added to the metal salt solution and the mixture heated.

The ligand to metal ion molar ratio can be varied between 0.25:1 to 4:1, but is preferably between 0.5:1 to 2:1.

It is possible to control growth of MOFs through the use of modulators, which tune the nucleation and growth rates of the MOF crystal. The role of many modulators, especially monocarboxylic acids, is to trap MOF particles early in the nucleation and growth process and deplete the local metal ion concentration, effectively slowing down the growth kinetics. The use of monocarboxylic acids as modulators such as acetic acid or formic acid is possible herein.

Where a modulator is used, the amount thereof may range from 0.001% to 50% of solvent used. The modulator may be used to reduce the average MOF particle size. In some cases, equal amounts of solvent and modulator can be used. Using more modulator tends to increase the size of the MOF particles in the framework.

The pore size of the MOF is preferably less than 30 Å, such as 2 to 25 Å or 2 to 20 Å, ideally, 15 Å or less, e.g. 8 to 12 Å. Pore size can be controlled through the nature of the metal ions and the ligand, e.g. through the length of the ligand. The pore window is preferably 2 to 10 Å, such as 3 to 5 Å. These pore sizes are designed to block the dissolved polysulfides from exiting the pores whilst allowing the permeation of Li+ ions. Moreover, the pore window is designed to prevent polysulfides penetrating the separator at all. These pore sizes and windows alleviate the problem of polysulfide shuttling and lithium dendrite formation.

The bimetallic MOF must be applied to the surface of the substrate to prepare the required separator. The surface coverage of the substrate may be high. Preferably at least 50% of the surface of the substrate is coated with MOF, such as at least 80%. It is preferred if the whole of the surface is covered. It may be that an adhesive is required to assist binding of the bimetallic MOF to the support. An inert adhesive may be used. The bimetallic MOF may therefore be combined with an inert adhesive to allow application to the substrate. Application may be effected simply by casting a solution of the bimetallic MOF onto the substrate.

In a preferred embodiment the bimetallic MOF is prepared by dissolving metal salts of the required metals in a solvent, typically water. Suitable salts are nitrates, sulphates or halides but any soluble salt is possible. The use of sulphates is preferred.

Into the solution is also added the ligands required to make the MOF, such as an imidazole ligand such as 2-methylimidazole. This mixture can be mixed for a prolonged period, such as 12 hrs or more to allow MOF growth to occur. This process can also be effected at low temperature such as 20 to 50° C.—there is no requirement for excessive heating to grow the MOF.

A particular advantage of the invention is that the bimetallic MOF, especially a Fe-doped ZIF such as a Fe-doped ZIF-8 can be prepared in a one-step solution phase synthesis method using water as the solvent. Such a process is environmentally benign and cost-effective. Moreover, the process can be effected at low temperatures of 20 to 50° C. such as 35° C. Contrast that process with the one disclosed in (Journal of Energy Chemistry 82 (2023) 484-496) which requires heating to 170° C. for 6 hrs and ethanol as a washing solvent.

The desired ratio of metal ions in the final MOF can be adjusted by changing the amounts of starting salts added.

The precipitate that forms can be isolated and worked up, e.g. collected by centrifugation, washed and dried.

The bimetallic MOF can then be applied to a substrate. This is easily achieved by simple casting of a slurry of the bimetallic MOF onto the substrate. A slurry containing the bimetallic MOF is conveniently prepared with Super P (carbon black), and PVDF in an inert solvent, such as N-methyl pyrrolidone. The obtained slurry can be cast onto a substrate and dried. Carbon black facilitates electron transportation and is utilized for trapping polysulfides. It is preferred therefore that the bimetallic MOF is applied to the substrate in the presence of carbon black in an inert solvent.

Finally, a porous protective layer may be applied over the bimetallic MOF simply to protect it from harm. Another substrate layer could be used in this regard.

### Battery

The separator of the invention can be used in an Li—S battery. The other parts of the battery can be conventional. The anode in such a battery is conventional and may comprise a Li alloy (e.g. with Al or Sn) or pure Li. The Li anode may be carried on a current collector such as a steel carrier. The Li anode may be combined with carbon to prevent problems associated with its expansion during charging and discharging cycles.

The cathode in the Li—S battery is elemental sulphur or other electroactive sulphur material. The sulphur or other electroactive sulphur-containing material may be mixed with an electrically conductive material (e.g. carbon black) to improve its electrical conductivity.

In a known method of cathode manufacture, carbon and sulphur are ground to form a physical mixture, which is mixed with solvent and binder to form a slurry. The slurry is applied to a current collector and then dried to remove the solvent. The resulting structure may be calendared to form a composite electrode precursor, which is cut into the desired shape to form a cathode.

The separator may be placed on the cathode and a lithium anode placed on the other side of the separator. The coated separator may be placed in any position between the cathode and lithium anode. Electrolyte is introduced into the cell to wet the cathode and separator.

The electrolyte used is typically a liquid organic electrolyte, and may be contained in the pores of a separator used to separate the electrodes. The electrolyte is a non-aqueous electrolyte. It comprises an organic solvent and a conducting salt. The organic solvents that may be used are inert under the reaction conditions prevailing in the accumulator. They are preferably selected from ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanone, sulpholane, dimethylsulphoxide, 3-methyl-1,3-oxazolidine-2-one, γ-butyrolactone, 1,2-diethoxymethane, tetrahydrofuran, 2-methyltetrahydrofuran, 1,3-dioxolan, methyl acetate, ethyl acetate, nitromethane, 1,3-propanesultone and mixtures of two or more of these solvents.

The conducting salt is preferably selected from LiPF₆, LiBF₄, LiClO₄, LiAsF₆, LiCF₃SO₃, LiN(CF₃SO₂)₂, LiC(CF₃SO₂)₃, LiSO₃CₓF₂ₓ₊₁, LiN(SO₂CₓF₂ₓ₋₁)₂ or LiC(SO₂CₓF₂ₓ₊₁)₃ with 0≤x≤8, Li[(C₂O₄)₂B] and mixtures of two or more of these salts.

The electrolyte plays a key role in Li—S batteries, acting both on “shuttle” effect by the polysulfide dissolution and the SEI stabilization at anode surface. Li—S batteries are conventionally employed cyclic ethers (as DOL) or short-chain ethers (as DME) as well as the family of glycol ethers, including DEGDME and TEGDME. One common electrolyte is LiTFSI in DOL:DME 1:1 vol. with LiNO₃ as additive for lithium surface passivation.

Preferably, polysulphide anions are added to the electrolyte of the lithium-sulphur battery, for example in the form of Li₂S₃, Li₂S₄, Li₂S₆, or Li₂S₈. In one embodiment, the quantity of added polysulphide is such that the electrolyte is saturated with polysulphide. In this manner, the loss of sulphur at the negative electrode can be compensated for. The polysulphide is preferably added before the battery is placed in service.

### Performance

Li—S batteries of the invention have remarkable performance, in particular in terms of capacity decay per cycle. In any rechargeable battery, there is a drop off of performance over time as the battery is used and then recharged. Key to the value of any rechargeable battery is that the drop in battery performance per cycle (i.e. charge discharge cycle) is minimal. We have demonstrated capacity decay of less than 0.04% per cycle over a period of 1000 cycles at 0.5° C. The battery of the invention may be viable after as many as 4000 cycles.

Experimental results confirm this invention provides high cyclic stability with a minimum decay rate per cycle.

A Li—S battery of the invention on cycling at 0.5 C, 1 C, 2 C, and 3 C, the capacities remained at 903 mAh g⁻¹, 830 mA h g⁻¹, 785 mA h g⁻¹ and 746 mA h g⁻¹, respectively. Finally, the capacity returned to 882 mA h g⁻¹ at 0.5 C, while the capacity decay was merely 0.06% per cycle.

A Li—S battery of the invention may have an areal sulphur loading of 0.1 to 9 mg cm⁻², preferably 0.5 to 5.0 mg cm-2.

A Li—S battery of the invention may have high areal sulphur loading of 0.1 to 9 mg cm⁻² and be used with different volumes of electrolyte such as 5 to 50 μL.

Areal sulfur loading means the amount of sulfur present (x mg) in the total area of the electrode (y cm⁻²). Higher loading of the sulfur leads to higher energy density of the Li—S battery. Less loading of sulfur and the addition of a high amount of electrolytes decreases the energy density of the battery. The reported areal sulfur loading allows therefore a reduction in the electrolyte volume.

A Li—S battery of the invention may employ an electrolyte to sulfur ratio of E:S=5 to 50 μL of electrolyte per mg of S.

A bimetallic MOF-coated separator of the invention shows no polarization effect and promotes uniform Li stripping and plating in Li∥Li symmetric cell even at very high current of 10 mA cm², which is highly desirable for the long-term cyclic stability of the battery.

Thermal shrinkage of the separator is a significant factor in the safety characteristics of the battery. The separator of the present invention is exceptionally thermally stable and does not shrink when subjected to heating, e.g. up to 150° C. Note that the substrate is shrinks at this temperature so the combination of the MOF and substrate remarkably offers thermal stability. This superior thermal tolerance could prevent internal electrical short circuits at elevated temperatures during cell cycling. Viewed from another aspect therefore the separator of the invention does not undergo thermal shrinkage when subject to heating up to 150° C.

The battery of the invention can be rapidly charged and is readily prepared on large scale.

### Use

The lithium-sulphur battery of the invention may be used to provide energy for, inter alia, mobile information devices, tools, electrically operated automobiles and automobiles with hybrid drives.

Whilst the invention has been described with reference to the use of the separator of the invention in Li—S batteries, it is envisaged that the claimed separator may have utility as a separator in other batteries such as metal sulphur batteries and lithium-ion batteries.

### Alternative Cathode Embodiment

Whilst the separator of the first embodiment can be used with a conventional sulphur containing cathode, in a further embodiment, the separator of the invention can be used in conjunction with a particular cathode described below in the second embodiment.

In one embodiment therefore the cathode of use comprises a reduced graphene oxide sheet chemically bound via the basal plane of said reduced graphene oxide to a metal-organic framework via an oxygen-metal linker, said metal organic framework being infused with sulphur to form a structure S-MOF@rGO wherein the weight of sulphur based on the weight of the S-MOF@GO is 50% to 90%. Preferably at least 50 wt % of the MOF present is bound to the reduced graphene oxide sheet.

The MOF used in the cathode in this embodiment can be the same or different to the one present in the separator but the principles of MOF growth are the same.

To manufacture the battery of the invention the cathode material might be pressed onto an aluminium foil current collector. To manufacture the anode, lithium film or a film with a lithium alloy may be pressed onto a suitable support. The separator can be impregnated with electrolyte and the electrodes laminated onto the saturated separator. A ready-charged battery is obtained.

### Detailed Description of Second Embodiment—Cathode

The present invention also relates to a material suitable for use in the cathode of a Li—S battery, which is based on a reduced graphene oxide which is chemically bound to a MOF.

The MOF@rGO structure can then be infused with sulphur to form a material suitable for use in the cathode in a Li—S battery along with a conventional anode and electrolyte. Key to the invention is that the binding of the MOF to a reduced graphene oxide (rGO) basal plane provides remarkably improved properties relative to solutions in which no such dedicated binding reaction takes place.

### Graphene Oxide

Graphene oxide (GO) is a derivative of graphene and is characterized as a two-dimensional nanomaterial. While graphene nanosheets solely consist of aromatic sp²-hybridized carbon atoms, GO can be described as a single graphitic monolayer of carbon atoms with randomly distributed aromatic regions and oxygenated aliphatic regions (sp³-hybridized). GO contains the oxygen in functional groups such as hydroxyl, epoxy, carbonyl and carboxyl groups. The hydroxyl and epoxy groups are primarily located on the basal plane of GO, while the carbonyl and carboxyl functional groups are located at the edges of the GO sheet. Coordination of metal ions via the hydroxyl and epoxy groups is preferred herein.

GO can be prepared by exfoliation into single-sheet GO with a thickness of approximately 1 nm by ultrasonication which breaks the interactions between adjacent layers. The functional groups also make it possible for GO to form relatively stable dispersions in polar solvents such as water and DMF, by hydrogen bonding between the solvent polar groups and the epoxy groups in the GO basal plane.

Loss or reduction of the oxygen-containing groups in reduced graphene oxide (which term herein covers partially reduced graphene oxide) makes the flakes less dispersible in water. The presence of a reduced graphene oxide can be determined as there is a change in the colour on reduction of graphene oxide. An aqueous solution of graphene oxide is pale yellow. An aqueous solution of reduced graphene oxide is black.

rGO can be obtained by applying various chemical, thermal and electrochemical procedures to GO, such as treating GO with hydrazine hydrate, exposing GO to hydrogen plasma for a few seconds, exposing GO to another form of strong pulse light, such as those produced by xenon flashtubes and heating GO in distilled water at varying degrees for different lengths of time.

The process of the invention starts with a graphene oxide sheet or reduced graphene oxide sheet, which contains oxygen atoms that are capable of coordinating with metal ions. In particular, those oxygen atoms are located on the basal plane and are ideally therefore epoxy or hydroxyl-based O atoms. Also, carboxylic groups are present that can coordinate.

Ideally, the starting graphene oxide is unreduced as this maximises the number of oxygen atoms that are available for coordination to metal ions. In the final cathode however, the graphene oxide is preferably reduced as rGO has much better conductivity.

GO or rGO sheets may be exfoliated using ultrasound to maximise the number of nucleating sites on the GO or rGO surface. The GO or rGO is typically present in an inert solvent such as DMF, water or methanol at this stage in the process. It is preferred if sulfuric acid is not used during the exfoliation step (e.g. to make the graphene porous) as sulphuric acid can cause dissolution of polysulfides and destroy the 2D structure of the GO. It is preferred therefore if the graphene oxide is ultrasonically exfoliated in the presence of a suitable organic solvent (such as DMF) only. Such a process introduces metal sites on the open 2D structure of graphene oxide.

It is preferred if the ultrasonication occurs without heating of the graphene oxide. There is no need for the graphene oxide to be subjected to solvothermal reaction. A solvothermal reaction, e.g. at a temperature of 100° C. reduces the GO and this step can be conveniently effected during MOF growth since active sites for metal binding are reduced Ideally therefore the exfoliation step occurs at lower temperature, e.g. 60° C. or below such as room temperature. It is particularly preferred therefore that the reduction of graphene oxide to rGO occurs simultaneously during the formation of the MOF. This maximises the efficiency of the process as only one thermal step is required.

Viewed from another aspect therefore, the invention provides a process for the preparation of a cathode material for a Li—S battery, said process comprising:
(i) exfoliating graphene oxide dispersed in an organic solvent by ultrasonication, preferably in the absence of sulphuric acid, to obtain exfoliated graphene oxide sheets dispersed in an organic solvent;
(ii) nucleating metal ions on the exfoliated graphene oxide sheets such that the metal ions are chemically bound to the basal plane of the graphene oxide sheets;
(iii) subsequently, growing a metal-organic framework comprising said chemically bound metal ions by adding to the product of step (i) a polyfunctional ligand and optionally heating the resulting mixture to a temperature of at least 20° C., such as 100 to 250° C. so as to form a metal organic framework bound to a reduced graphene oxide sheet (MOF@rGO);
(iv) infusing elemental sulphur into the metal organic framework to form S-MOF@rGO such that the weight of sulphur based on the weight of the S-MOF@rGO is 50% to 90%.

Viewed from another aspect therefore, the invention provides a process for the preparation of a cathode material for a Li—S battery, said process comprising:
(i) exfoliating graphene oxide dispersed in an organic solvent by ultrasonication at a temperature less than 60° C., such as room temperature, to obtain exfoliated graphene oxide sheets dispersed in an organic solvent;
(ii) nucleating metal ions on the exfoliated graphene oxide sheets such that the metal ions are chemically bound to the basal plane of the graphene oxide sheets;
(iii) subsequently, growing a metal-organic framework comprising said chemically bound metal ions by adding to the product of step (i) a polyfunctional ligand and optionally heating the resulting mixture to a temperature of at least 20° C., such as 100 to 250° C. so as to form a metal organic framework bound to a reduced graphene oxide sheet (MOF@rGO);
(iv) infusing elemental sulphur into the metal organic framework to form S-MOF@rGO such that the weight of sulphur based on the weight of the S-MOF@rGO is 50% to 90%.

In the first stage of the process, metal ions coordinate to the graphene oxide or rGO via the heterogeneous nucleation sites on the graphene oxide or rGO surface provided by the oxygen atoms. Suitable metal ions are transition metal ions such as 1^{st} row transition metals ions. The use of Zr, Co, Zn, Cr, or Cu is preferred, especially Zr or Cr. By anchoring the metal ions to the graphene oxide or rGO sheet via the oxygen atoms thereon, as the metal-organic framework grows, it is chemically bound to the graphene oxide or rGO surface. Any metal-organic frameworks that are not chemically bound to the surface should be removed later in the process as this strong chemical bond between the graphene oxide sheet and the metal ion is important for the cathode performance.

The coordination of the metal ions to the graphene oxide or rGO surface may occur on one surface thereof or both surfaces thereof, preferably both surfaces.

Delivery of the metal ions to the graphene oxide or rGO surface typically occurs in an inert solvent and uses a salt of the metal in question which is soluble in that solvent. Where the GO or rGO is already present in a solvent, the required metal salt can simply be added to the solvent in an appropriate amount. Preferred metal salts are nitrates, sulfates, acetonates or halides such as chlorides.

For example, a 0.1 to 1.0 M solution of a metal salt in water can be added to a dispersion of the GO or rGO in solvent. The amount of metal ions added can vary but typically for 20 mg of GO or rGO, the addition of 0.1 to 1.0 mmol of metal salt is appropriate.

This process can be effected in the absence of amino compounds. This process can be effected in the absence of urea.

Viewed from another aspect, the invention provides a process for the preparation of a cathode material for a Li—S battery, said process comprising:
(i) nucleating metal ions on a graphene oxide or reduced graphene oxide sheet in the absence of urea such that the metal ions are chemically bound to the basal plane of the graphene oxide or reduced graphene oxide sheet;
(ii) subsequently, growing a metal-organic framework comprising said chemically bound metal ions by adding to the product of step (i) a polyfunctional ligand and optionally heating the resulting mixture to a temperature of at least 20° C., such as 100 to 250° C. so as to form a metal organic framework bound to a reduced graphene oxide sheet (MOF@rGO);
(iii) infusing elemental sulphur into the metal organic framework to form S-MOF@rGO such that the weight of sulphur based on the weight of the S-MOF@rGO is 50% to 90%.

Contact between the graphene oxide sheet or reduced graphene oxide sheet and the metal ions can be carried out for at least 10 mins, e.g. up to 60 mins. Sonication can be used to encourage coordination of the metal ions to the oxygen atoms on the basal planes of the graphene oxide sheet or reduced graphene oxide sheet.

pH can be used to manipulate the binding of metal ions. In general, more basic pHs are preferred especially more than 7, such as 8 to 12. A higher pH leads to improved nucleation and higher oxygen deprotonation. The metal cations are more likely to interact with the GO or rGO surface if the oxygen functional groups are deprotonated, which can be achieved by raising the pH of the starting GO dispersion. By increasing the pH to 9.8 or more, ionization of hydroxyl groups on the GO surface occurs and allows maximum coordination of the metal ions to basal planes. Increasing pH also increases MOF packing density.

Once the initial coordination to the graphene oxide or reduced graphene oxide surface has been completed, the unbound metal ions can be separated from those bound to the graphene oxide or reduced graphene oxide by centrifuging and decantation. This also allows determination of the metal binding level as the difference between the amount of metal ions supplied and those found in the unbound supernatant. It is preferred however if no such step occurs, as the residual metal ions can become incorporated within the MOF as it grows.

Once the initial metal ions are coordinated to the graphene oxide or reduced graphene oxide surface, growth of the metal organic framework can begin. Crucially therefore, metal ions are coordinated with the basal surfaces of the GO or rGO before the MOF ligands are added.

This growth method offers several advantages as it makes it possible to ensure grafting between the MOF and GO or rGO and not just physical mixing of the constituents, while at the same time obtaining densely packed and small MOFs, thus providing a large specific surface area.

### Metal-Organic Frameworks for the Cathode Embodiment

Metal-Organic Frameworks (MOFs) are porous nanomaterials composed of metal ion clusters linked together by organic ligands into three-dimensional structures. The variety of possible constituents has led to more than 20,000 different MOFs being reported. In between the organic and inorganic building units, cavities with well-defined openings emerge, called pores herein. These pores have a volume (i.e. a pore size) and a pore opening (or pore window) which governs how large a molecule can pass into a pore and pass out of the pore. Depending on the constituents chosen, the pore openings can be as large as 10 nm and the surface area within the pore can be tuned from 1,000 to 10,000 m²/g.

The growth mechanism of MOFs has been widely investigated, and it generally accepted that the MOF forming process happens by nucleation and spreading, where nuclei with surface adsorbed organic ligands aggregate into an inorganic-organic crystal. The formation of MOFs can be described by three steps, where the first is the deprotonation of organic ligands followed by complexation of these deprotonated ligands with metal ions. Secondly, after large collections of these metal-ligand complexes or oligomers are formed, they can coalesce into MOF crystals. Further growth of these particles is caused by diffusion of oligomers to the particle surface. Lastly, growth is terminated, either when the system reaches equilibrium with respect to the solvated species in solution, or by the use of terminal capping agents.

It will be appreciated that as the MOF grows, more metal ions become incorporated into the structure and hence the MOF growth process requires the presence of a metal salt, typically the same as the one used in the coordination step.

Ligands used to grow the MOF are well known and are based on polyfunctional organic ligands such as those comprising carboxyl groups, amine groups and optionally other functional groups. In one embodiment, an imidazole type ligand is used such as 2-methylimidazole salt. In one embodiment, a polyfunctional organic ligand which comprises at least one carboxyl group, such as a carboxylic acid, is used. Ligands comprising at least two carboxyl groups are preferred. Ligands are generally small molecules having a Mw of up to 300 g/mol.

The use therefore of small molecule tri or dicarboxylic acids is preferred such as 1,4-benzenedicarboxylic acid or 1,3,5-benzenetricarboxylic acid. Ligands of interest often contain an aromatic ring such as a phenyl ring. Most preferred ligands therefore are based on a polycarboxylic acid with aromatic ring.

Some ligands might contain both carboxyl and amino groups such as 2-aminoterephthalic acid.

Hydrothermal and solvothermal approaches are the synthesis techniques most frequently reported for MOF synthesis. In this solution-based method, a solution containing the metal ion precursors and the ligand precursors is placed inside a sealed reaction container which is heated to temperatures around the boiling point for the solvent used. At these elevated temperatures (and optionally pressures from 1 to 200 bars), crystallization of a product occurs.

Another synthesis technique available for MOF synthesis, is ultrasound-assisted synthesis, also referred to as sonochemical synthesis. In this solution-based method, a solution containing the metal ion precursor and the ligand precursor is placed in a sonication bath where it is exposed to high-energy ultrasonic waves for a period of time. The high-energy waves interact with the liquid and create cyclic alternating regions with high and low pressure, which again forms cavities within the liquid. These cavities grow due to diffusion of solute vapor into the cavities caused by the ultrasonic waves until they become unstable and collapse. By then, there has been an accumulation of ultrasonic energy within these cavities, which is rapidly released upon collapse. This leads to local heating and cooling rates up 1000 K/s. These extreme conditions lead to excitation of molecules, molecular bond breakage and formation of radicals which can react further, causing nucleation and growth of MOF nanoparticles. Compared to other MOF synthesis techniques, sonochemical synthesis can be performed at room temperature or at relatively low synthesis temperatures. In addition, more homogeneous products can be obtained due to the dissolution and mixing of the precursors.

In the present invention the hydrothermal method is preferred and hence after the coordination step, it is preferred if a solution of the polyfunctional ligand is added to the metal salt solution and the mixture heated to elevated temperature. Elevated temperatures may be used such as 20 to 250° C., preferably 50 to 250° C., such as 100 to 200° C.

The ligand to metal ion molar ratio can be varied between 0.25:1 to 4:1, but is preferably between 0.5:1 to 2:1.

It is possible to control growth of MOFs through the use of modulators, which tune the nucleation and growth rates of the MOF crystal. The role of many modulators, especially monocarboxylic acids, is to trap MOF particles early in the nucleation and growth process and deplete the local metal ion concentration, effectively slowing down the growth kinetics. The use of monocarboxylic acids as modulators such as acetic acid or formic acid is possible herein.

Where a modulator is used, the amount thereof may range from 0.001% to 50% of solvent used. The modulator may be used to reduce the average MOF particle size. In some cases, equal amounts of solvent and modulator can be used. Using more modulator tends to increase the size of the MOF particles in the framework.

The use of NH₂-UiO-66(Zr) or MIL101(Cr) is preferred as the MOF.

At the temperatures used in the MOF synthesis, a graphene oxide is typically reduced to reduced graphene oxide. This can be confirmed by the change in the colour of the GO solution from pale yellow to black after heating which is a reduced form of the GO.

Once the framework is grown, the material can be purified to remove any unbound MOFs. It will be appreciated that many pristine (unbound) MOFs may have grown in the preparation process but some MOFs will also be bound to the reduced graphene oxide surface via the metal ions initially coordinated to the basal planes of the graphene oxide. The cathode in the present case should comprise those MOFs that are physically bound to the reduced GO basal planes and hence it is preferred if the unbound MOFs are removed as these are detrimental to performance.

Any bound MOF will withstand sonication of the material and will remain chemically bound to the surface of the rGO. The reaction mixture can therefore be sonicated and/or centrifuged such that pristine MOFs remain in the supernatant whilst the MOF@rGOs sediment at the bottom of the tube. Multiple rounds of centrifugation can be used to ensure purity. Speeds of 2500 to 6000 rpm are suitable. It is preferred that at least 90 wt % of the MOF is physically bound to the rGO. After centrifuging, the material may be dried, e.g. to remove any water.

In a MOF@rGO type structure, it is preferred if the MOF forms the majority of the weight of the structure. The MOF is preferably 60 to 98 wt %, such as 70 to 97.5 wt % of the structure. Correspondingly, the rGO forms 2 to 40 wt %, such as 2.5 to 30 wt % of the structure.

The pore size of the MOF is preferably less than 30 Å, such as 2 to 25 Å, ideally 15 Å or less. Pore size can be controlled through the nature of the metal ion and the ligand, e.g. through the length of the ligand. The pore window is preferably 4 to 11 Å. This pore size is ideal to block the dissolved polysulfides from exiting the pores whilst allowing the permeation of Li+ ions. This pore size alleviates the problem of polysulfide shuttling and lithium dendrite formation.

The surface coverage of the rGO sheet may be high and can be tuned by pH change or nucleation time of metal coordination. Preferably at least 50 wt % of the MOF present is bound to the reduced graphene oxide sheet. It is preferred if the MOF is evenly distributed across the reduced graphene oxide sheet.

As noted above, the temperature used in MOF synthesis may also have the effect of reducing the GO. In one embodiment therefore, the process of the invention involves a GO starting material and after coordination of the metal ions on the GO basal planes, MOF growth at high temperature simultaneously allows MOF growth and GO reduction. Alternatively, it may be that the skilled person starts the process of the invention with a reduced graphene oxide sheet. What is important is that in the final cathode a reduced graphene oxide is present.

### Sulphur Addition

Once the MOF is present on the rGO, it is necessary to create the actual cathode through the introduction of sulphur thereto. Sulphur is preferably loaded into MOF@rGO by a melt diffusion method. By using this method elemental sulphur can melt and then be infused into the MOF as sulphur in its elemental form can pass through the pore windows in the MOF and be retained there. This process can be effected in an inert atmosphere, such as in the absence of air. In one embodiment, the sulphur and MOF@rGO are placed in a sealed vial and heated to above the melting point of sulphur to enable infusion to occur.

Loading can therefore be effected by melt diffusion where sulphur is simply melted and allowed to infuse into the pores of the MOF. Lithium sulphides that form in battery operation are then constrained within the pores. The amount of sulphur loaded is preferably at least 50 wt % of the weight of the S-MOF@rGO material, such as 60 to 90 wt % of the S-MOF@rGO material. Determination of the sulphur loading can be measured by thermogravimetric analysis. For example, a thermogravimetric analysis system (TGA) can be used in the presence of an inert atmosphere by measuring the weight loss of sulfur with the passage of time and/or increasing the temperature.

Alternatively, the loaded amount can be determined during the manufacturing process based on the weight of MOF+rGO used and the amount of S added (taking into account S recovered as unbound in the process).

In one embodiment, loading of the sulphur into the MOF@rGO can be accomplished by mixing and grinding the sulphur and MOF@rGO into a fine powder. Then, the mixture can be heated, e.g. in an autoclave, to a temperature above the melting point of sulphur, e.g. at least 100° C., such as at least 120° C. such as 130 to 200° C., e.g. 155° C. Sulfur loaded MOF@rGO can then be collected after cooling. The product can be further ground if required. This is labelled S-MOF@rGO herein.

In one embodiment, the heating of the sulphur loaded MOF@rGO can be carried out for 8 to 30 hrs, such as 10 to 20 hrs.

In general the whole process of the invention can be effected in the absence of strong acids such as mineral acids. In general the process of the invention can be effected in the absence of sulphuric acid.

In general the process of the invention can be effected in the absence of any inert atmospheres such as using argon atmospheres. Processes which require inert atmospheres are of limited industrial interest.

Viewed from another aspect the invention provides a process for the preparation of a cathode material for a Li—S battery, said process comprising:
(i) nucleating metal ions on a graphene oxide or reduced graphene oxide sheet such that the metal ions are chemically bound to the basal plane of the graphene oxide or reduced graphene oxide sheet;
(ii) subsequently, growing a metal-organic framework comprising said chemically bound metal ions by adding to the product of step (i) a polyfunctional ligand and optionally heating the resulting mixture to a temperature of at least 20° C., such as 100 to 250° C. so as to form a metal organic framework bound to a reduced graphene oxide sheet (MOF@rGO);
(iii) infusing elemental sulphur into the metal organic framework in air to form S-MOF@rGO such that the weight of sulphur based on the weight of the S-MOF@rGO is 50% to 90%.

The resulting material is suitable for use in a cathode in a Li—S battery. It will be appreciated that the form of the material may need to be manipulated for use in an actual cell.

The cathode may be carried on a current collector such as an Al foil or carbon coated Al foil. It may therefore form a thin layer on the current collector.

### Battery

The sulphur infused MOF@rGOs of the invention can be used as a cathode in an Li—S battery. A cathode can be prepared by combining the S-MOF@rGOs and any required additives and milling the mixture that is formed. Typical additives include polyvinylfluoride and a polycarboxylate dispersant. It is preferred if the cathode comprises at least 60 wt % of the S-MOF@rGOs.

The S-MOF@rGO powder can be dispersed in a liquid carrier (along with any additives) and this dispersion can be cast, e.g. on a metal foil such as aluminium foil and allowed to dry. Cathodes can then be cut in an appropriate size.

The other parts of the battery can be conventional. The anode in such a battery is conventional and may comprise a Li alloy (e.g. with Al or Sn) or pure Li. The Li anode may be carried on a current collector such as a steel carrier. The Li anode may be combined with carbon to prevent problems associated with its expansion during charging and discharging cycles.

The electrolyte used is typically a liquid organic electrolyte, and may be contained in the pores of a separator used to separate the electrodes. The electrolyte is a non-aqueous electrolyte. It comprises an organic solvent and a conducting salt. The organic solvents that may be used are inert under the reaction conditions prevailing in the accumulator. They are preferably selected from ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanone, sulpholane, dimethylsulphoxide, 3-methyl-1,3-oxazolidine-2-one, γ-butyrolactone, 1,2-diethoxymethane, tetrahydrofuran, 2-methyltetrahydrofuran, 1,3-dioxolan, methyl acetate, ethyl acetate, nitromethane, 1,3-propanesultone and mixtures of two or more of these solvents.

The conducting salt is preferably selected from LiPF₆, LiBF₄, LiClO₄, LiAsF₆, LiCF₃SO₃, LiN(CF₃SO₂)₂, LiC(CF₃SO₂)₃, LiSO₃CₓF₂ₓ₊₁, LiN(SO₂CₓF₂ₓ₋₁)₂ or LiC(SO₂CₓF₂ₓ₊₁)₃ with 0≤x≤8, Li[(C₂O₄)₂B] and mixtures of two or more of these salts.

The electrolyte plays a key role in Li—S batteries, acting both on “shuttle” effect by the polysulfide dissolution and the SEI stabilization at anode surface. Li—S batteries are conventionally employed cyclic ethers (as DOL) or short-chain ethers (as DME) as well as the family of glycol ethers, including DEGDME and TEGDME. One common electrolyte is LiTFSI in DOL:DME 1:1 vol. with LiNO₃ as additive for lithium surface passivation.

Preferably, polysulphide anions are added to the electrolyte of the lithium-sulphur battery, for example in the form of Li₂S₃, Li₂S₄, Li₂S₆ or Li₂S₈. In one embodiment, the quantity of added polysulphide is such that the electrolyte is saturated with polysulphide. In this manner, the loss of sulphur at the negative electrode can be compensated for. The polysulphide is preferably added before the battery is placed in service.

### Separator

A separator may be used between electrodes, often a polymeric porous separator such as polypropylene is used. Other polymers of interest in the separator include polyesters, polyolefins, polyamides, polyacrylonitriles, polyimides, polyetherimides, polysulphones, polyamideimides, polyethers, polyphenylenesulphides and aramids, or mixtures of two or more of these polymers.

In one embodiment a separator comprising a MOF can be used as described above in the first embodiment. In one embodiment therefore the separator between the anode and cathode is functionalised to carry a MOF. Unlike the MOF used in the cathode, this MOF can be synthesised separately and coated onto a separator such as a polymeric separator. The MOF can form therefore a thin film on the separator, such as 1 to 5 microns thick film thereon.

In a preferred embodiment two metals are used in the manufacture of the MOF used for the separator, ideally two 1^{st} row transition metals, in particular Fe, especially Zn and Fe. The MOF is therefore bimetallic. If Zn and Fe are used it is preferred if the Zn metal is used in molar excess, such as Zn:Fe or 10:1 to 3:1.

The use of a bimetallic MOF as a coating on a separator support may offer advantages as such a separator prevents lithium sulphides from crossing the separator. The metal nodes in the MOF act as anchoring sites for lithium sulphide adsorption. The small pore size and pore window size acts as a molecular sieve for Li and polysulphides.

The ligands used to make the MOF can be the same as those defined above to prepare the cathode.

The present invention solves the problem of the polysulphide shuttle as the sulphur within the pores of the MOF is electrochemically attracted to the metal ions and does not readily escape from the pores of the MOF. Moreover, during the battery operation the cathode of the present invention encourages the formation of Li₂S₂ and Li₂S rather than soluble sulphides such as Li₂Sx where x is 8, 6, 4 or 3.

To manufacture the battery of the invention the cathode material might be pressed onto an aluminium foil current collector. To manufacture the anode, lithium film or a film with a lithium alloy may be pressed onto a suitable support. A separator can be impregnated with electrolyte and the electrodes laminated onto the saturated separator. A ready-charged battery is obtained.

### Performance

Li—S batteries of the second embodiment have remarkable performance, in particular in terms of capacity decay per cycle. In any rechargeable battery, there is a drop off of performance over time as the battery is used then recharged. Key to the value of any rechargeable battery is that the drop in battery performance per cycle (i.e. charge discharge cycle) is minimal. We have demonstrated capacity decay of less than 0.05% per cycle over a period of 1000 cycles.

Experimental results confirm this invention provides high cyclic stability with a minimum decay rate per cycle. The S-MOF@rGO with 75 wt % sulfur loading exhibits the capacity decay of 0.02% per cycle only even after 1000 cycles which is multiple times higher than many of the synthesized and reported cathode materials for Li—S batteries.

The cathode of the invention is thermally stable, showing the same weight loss and thermal degradation as a material in which the MOF is not bound to the rGO.

The cathode of the invention has an exceptionally high initial capacity, e.g. at least 1000 mAh g⁻¹ and possibly at least 1300 mAh g⁻¹. Values up to 2000 mAh g⁻¹ are envisaged. The reversible capacity may be at least 1200 mAh g⁻¹ after 20 cycles.

A Li—S battery of the invention may have an areal sulphur loading of 0.1 to 9 mg cm⁻², preferably 0.5 to 5.0 mg cm-2.

A Li—S battery of the invention may have high areal sulphur loading of 0.1 to 9 mg cm⁻² and be used with different volumes of electrolyte such as 5 to 50 μL.

Areal sulfur loading means the amount of sulfur present (x mg) in the total area of the electrode (y cm⁻²). Higher loading of the sulfur leads to higher energy density of the Li—S battery. Less loading of sulfur and the addition of a high amount of electrolytes decreases the energy density of the battery. The reported areal sulfur loading allows therefore a reduction in the electrolyte volume.

A Li—S battery of the invention may employ an electrolyte to sulfur ratio of E:S=5 to 50 μL of electrolyte per mg of S.

The battery of the invention can be rapidly charged and is readily prepared on large scale.

### Use

The lithium-sulphur battery of the invention may be used to provide energy for mobile information devices, tools, electrically operated automobiles and automobiles with hybrid drives.

The invention will now be described with reference to the following non-limiting examples and figures.

### EXAMPLES

### Example 1 and Brief Description of Figures

A Zn/Fe—ZIF-8 metal-organic framework was prepared by a one-step solution phase synthesis method using binuclear Fe and Zn paddle and methylimidazole linkers in water at 35° C.

### Synthesis of Bimetallic ZIF-8 and Fe-doped ZIF-8:

ZIF-8 was synthesized following the following steps:
1) dissolving the ZnSO₄·7H₂O (575 mg) in 30 mL of water and 1.314 g of 2-Methylimidazole in 30 mL of water in another beaker.
2) Stir the solutions for several minutes at room temperature and add the metal solution into the solution of 2-Methylimidazole followed by continuously stirring for 24 h at 35° C.
3) The white precipitate in the beaker was collected by centrifugation, washed with DI water, and dried for 12 h at 70° C.

The Fe-doped ZIF-8 was synthesized by the same method but FeSO₄·7H2O (46.3 mg) was also added to the aqueous solution of ZnSO₄·7H₂O in step 1. The subsequent steps are the same as with ZIF-8. The obtained samples were labeled as ZIF-8 and Fe— ZIF-8.

### Fabrication of Modified Separator:

ZIF-8 and Fe—ZIF-8 modified separators were engineered by coating the slurry containing ZIF-8 and Fe—ZIF-8, Super P, and PVDF onto the Celgard 2400. Briefly, the slurry was prepared by mixing Fe—ZIF-8, Super-P, and PVDF in NMP in a weight ratio of 75:15:10, respectively, and ball milled in a sealed Teflon jar for about 40 minutes. The obtained slurry was cast onto a Celgard 2400 separator and dried at 60° C. for 12 h. After drying, the modified separator was punched into a round shape with a diameter of 19 mm.

### Preparation of Sulfur Electrodes:

Sulfur was loaded in CNT/GO (1:1) by the conventional melt-diffusion method. In brief, sulfur powder and CNT/GO were thoroughly mixed by grinding and then sealed in a glass vial. The glass vial was then transferred inside the autoclave and heated at 155° C. for 12 hours. The slurry for the cathode was fabricated by mixing S-CNT/GO powder (90 wt. %) with a PVDF binder (10 wt. %) using NMP as the solvent. The obtained slurry was then cast onto carbon-coated Al foil by the doctor's blade and dried at 60° C. for 12 h to prepare electrodes. Finally, the electrodes were cut into 12 mm discs. The areal sulfur loading in the resultant cathode is in the range of 1-3.6 mg cm⁻².

The thickness of the bimetallic Fe—ZIF-8 separator is 1 to 15 microns. The thickness of the Celgard layer was 25 microns.

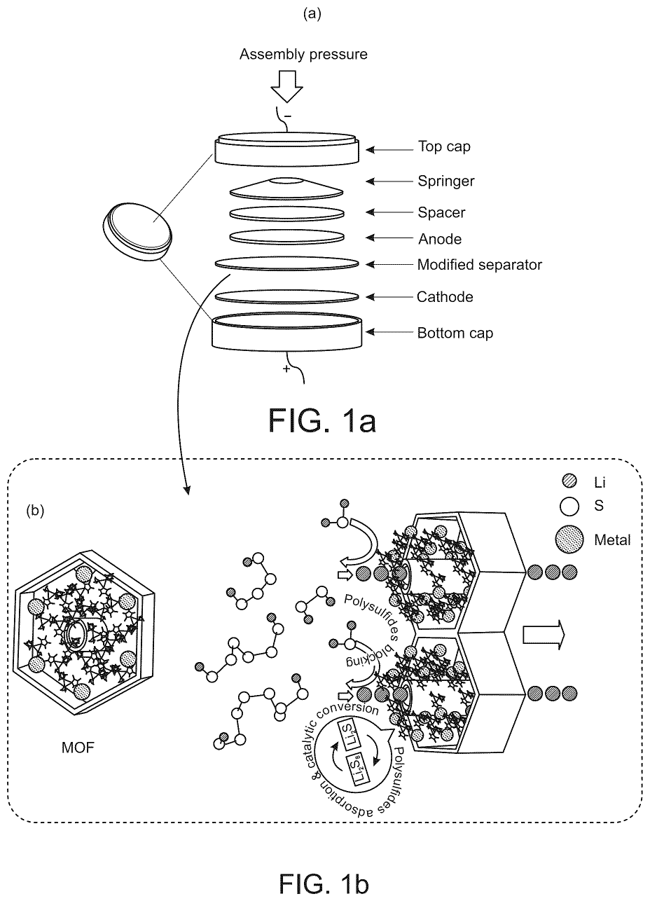

The bimetallic Fe—ZIF-8 separator made in Example 1 was subject to testing as explained in FIGS. 1 to 12. FIG. 1a shows a coin cell was prepared using an S-carbon cathode, Celgard (polypropylene) or MOF-modified separator as prepared in example 1, liquid electrolyte, Li anode, spacer, spring, and top cap. The liquid electrolyte used was 1 M LiTFSI and 0.1 M LiNO₃ in 1:1 (v/v) 1,2-dimethoxyethane (DME) and 1,3-dioxacyclopentane (DOL).

The electrochemical cell has a Li anode, a cathode comprising sulfur and carbon black, Celgard 2400 separator, and liquid electrolyte in an Ar-filled glove box. This is illustrated in FIG. 1a. The amount of sulphur loaded in the cathode is at least 50 wt % of the weight of the S-carbon material, such as 60 to 90 wt % of the S-carbon material. Determination of the sulphur loading can be measured by thermogravimetric analysis. For example, a thermogravimetric analysis system (TGA) can be used in the presence of an inert atmosphere by measuring the weight loss of sulfur with the passage of time and/or increasing the temperature.

FIG. 1b is a schematic illustration of the functional bimetallic 3D MOF-based separator of example 1 designed specifically for Li—S batteries that selectively blocks and converts polysulfides while providing even transport of Li⁺ ions due to highly ordered micropores with pore sizes of ˜10 Å, which is significantly smaller than the diameters of intermediate chain length lithium polysulfide.

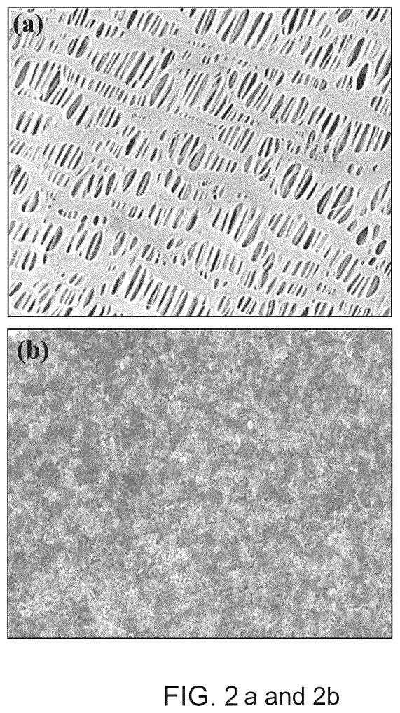

FIGS. 2a and 2b show the SEM images of the Celgard (PP) separator and MOF-coated Celgard separator of example 1. The SEM images of pristine PP contain a porous structure with pores in a wide range of up to several hundreds of nanometers, which allows the penetration of polysulfides dissolved in the electrolyte (FIG. 2a), while the SEM images of the MOF-coated separator clearly show that the separator is fully coated with the MOF (FIG. 2b). This coating provides the pore structures and functionality that blocks polysulfides.

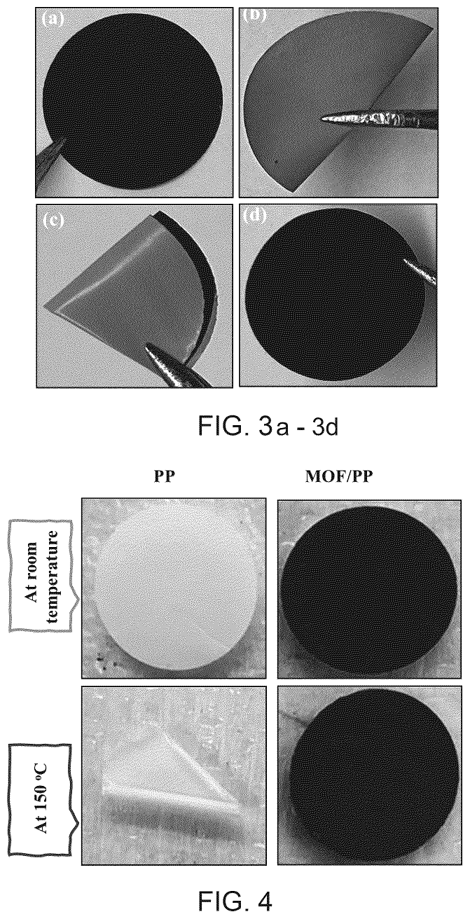

FIGS. 3a-3d depict the digital images of the modified separator demonstrating that the PP separator is fully covered with MOF (FIG. 3a). The MOF-coated separator was twisted twice but it has the ability to hold its initial shape, which implies that MOF is firmly bounded to the separator and possesses high mechanical stability with sufficient flexibility (FIGS. 3c-3d).

FIG. 4 shows the thermal shrinkage test of the Celgard and MOF-coated Celgard separator of example 1 at room temperature and at 150° C. Minimal thermal shrinkage of the separator is required to prevent internal short circuits of batteries at elevated temperatures. As presented in FIG. 4, the commercial Celgard separator shrinks completely at 150° C. Such high thermal shrinkage of the Celgard could result in an increased safety risk during thermal runaways. However, MOF-coated separator shows better thermal resistance capability. Even at 150° C. it retained its original shape.

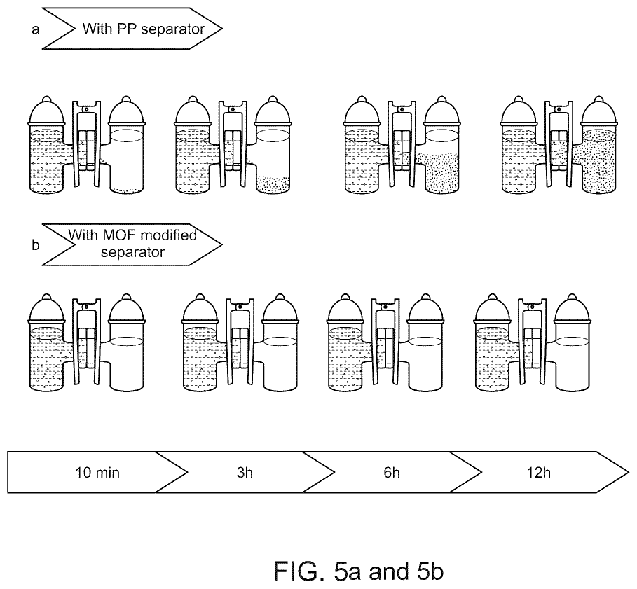

FIGS. 5a and 5b demonstrate the polysulfide permeation test with a PP separator and MOF-coated PP separator of example 1. High permeation resistance towards soluble polysulfides is critical for modified separators in Li—S batteries. In this regard, the permeation experiment was conducted by using an H-shape cell to examine the polysulfide permeation across the separators (FIG. 5a, b). The polysulfide solution (Li₂S₆) was added to the left side (black) and the blank electrolyte was introduced into the right side of the cell (colourless). The polysulfide permeation for the PP, MOF/PP modified separator of example 1 was investigated under similar conditions for different periods of time.

For the PP separator, polysulfides diffuse to the right side of the H-cell quickly after 10 min, implying a poor capability of the highly porous PP separator in preventing the diffusion of the polysulfides (FIG. 5a). In contrast, the MOF/PP separator of example 1 demonstrates significant improvement in blocking the polysulfides. Even after 12 h, the polysulfide migration is still negligible, showing the superior polysulfide blocking capability of the MOF/PP separator (FIG. 5b). The polysulfide permeability test confirms that the MOF/PP separator has the ability to mitigate the shuttling of polysulfides.

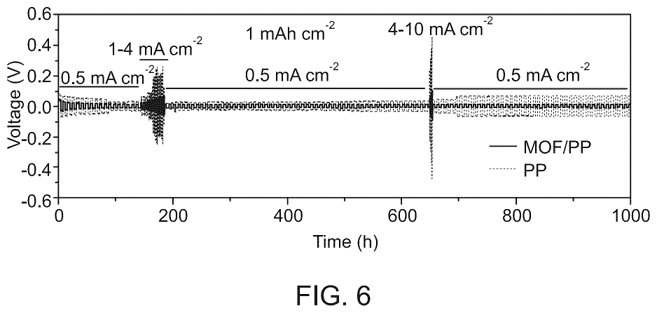

FIG. 6 shows the Li plating/stripping performance in symmetric cells with PP and MOF/PP, separators at different current densities with an areal capacity of 1 mA h cm⁻². Li∥Li symmetric cells were employed to evaluate the polarization effect by using PP, and MOF/PP separators. The Li electrode with the PP separator exhibits a high initial overpotential (72 mV) at a current density of 0.5 mA cm⁻² and an areal capacity of 1 mA h cm⁻². However, Li∥Li symmetric with MOF/PP delivers the minimum polarization (36 mV). Likewise, symmetric cells with the MOF/PP separator also show steady polarization vibrations with increased current densities from 1 to 10 mA cm-2 under an areal capacity of 1 mA h cm⁻². The voltage hysteresis of the symmetrical cell with the PP separator started to increase around 700 h, which is probably due to the growth of Li dendrites and the consumption of electrolytes.

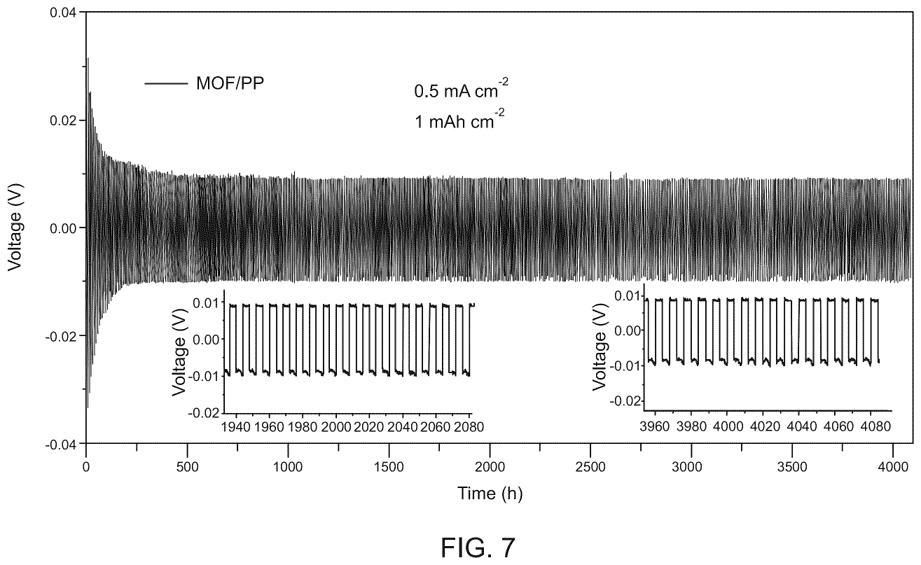

FIG. 7 shows the ultra-long-term cycling performance of a symmetric cell with a MOF/PP separator of example 1 at a current density of 0.5 mA cm⁻² with an areal capacity of 1 mA h cm⁻², which performed stably for more than 4000 h with a low voltage hysteresis.

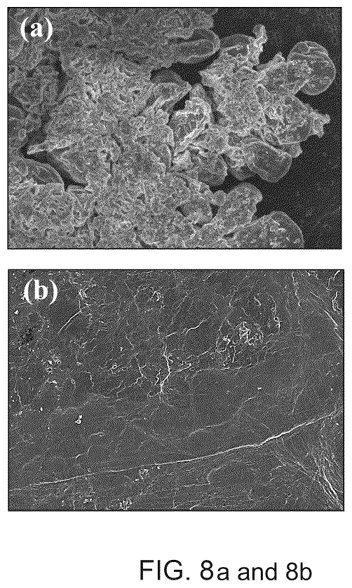

FIGS. 8a, 8b shows the SEM images of Li anodes with PP separator (8a) and MOF-protected PP separator (8b). To reveal the role of Fe—ZIF-8/PP in the Li plating/stripping process, the surface morphologies of the Li plate after 1000 h cycles were examined by SEM. The surface of Li metal with a conventional PP separator presents cluttered Li dendrites (FIG. 8a), but that with the MOF/PP separator still maintains a smooth surface (FIG. 8b), indicating a more effective function of the MOF/PP separator in suppressing the growth of lithium dendrites.

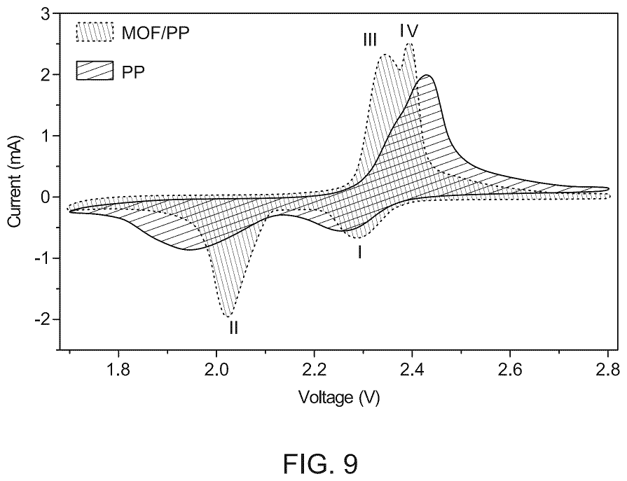

FIG. 9 shows the cyclic voltammetric curves of Li—S batteries with PP and MOF/PP separators under the voltage window of 1.7-2.8 V at a scan rate of 0.1 mV/s. Two distinct reduction peaks I and II were assigned to the conversion of S₈ molecule to high-order soluble polysulfides and their further transformation to Li₂S₂ and Li₂S. The oxidation peaks (Ill and IV) corresponding to the conversion of Li₂S₂ and Li₂S to the sulfur molecule. However, the CV curve of MOF/PP showed two sharp redox peaks, i.e., the significant negative move of the oxidation peak and the positive move of the reduction peak, suggesting the reducing polarization and much better electrocatalysis, while the well-echoed peaks indicate the reversible electrochemical reactions that occurred in the electrode materials.

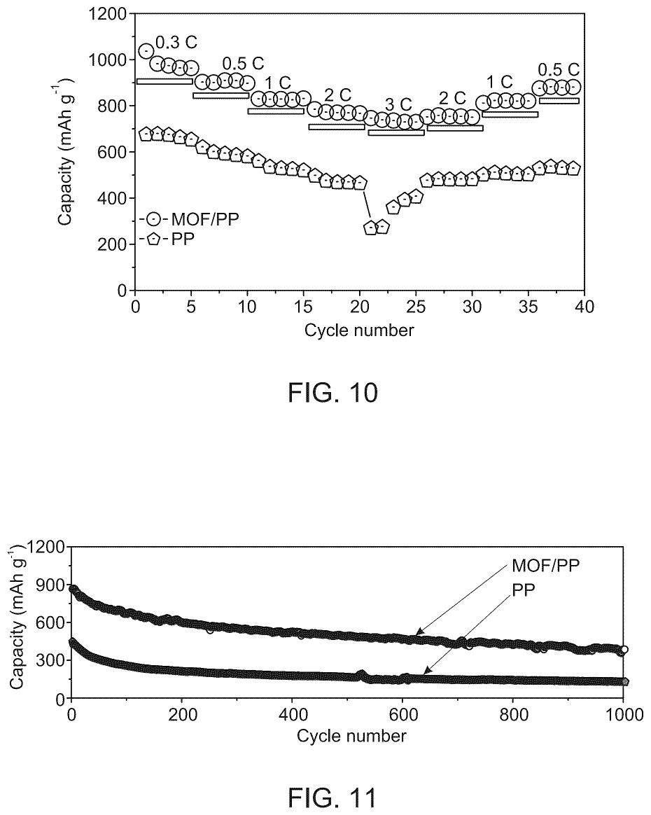

FIG. 10 shows the rate capability at different current rates (C—rates) for Li—S batteries with PP (lower curve) and MOF/PP (higher curve) separators under the voltage window of 1.7-2.8 V. The battery with the PP separator showed dramatic capacity decay at different C-rates. In contrast, the Li—S battery with MOF-coated separator demonstrated much better performance (1036 mA h g⁻¹ at 0.3 C). On cycling at 0.5 C, 1 C, 2 C, and 3 C, the capacities remained at 903 mAh g⁻¹, 830 mA h g⁻¹, 785 mA h g⁻¹ and 746 mA h g⁻¹, respectively. Finally, the capacity returned to 882 mA h g⁻¹ at 0.5 C, while the capacity decay was merely 0.06% per cycle.

FIG. 11 shows the cyclic performance of the Li—S batteries with PP (lower curve) and MOF/PP (higher curve) separators, S-Carbon cathode, and Li anode into the coin cell described herein. Li—S battery with MOF/PP exhibits 865 mAh g⁻¹ discharge capacity, ending with 409 mAh g⁻¹ after 1000 cycles with a Coulombic efficiency of ˜100%. In contrast, PP showed lower initial capacities (466 mAh g⁻¹), endings with 167 mAh g⁻¹ after 1000 cycles, and Coulombic efficiency of >100%.

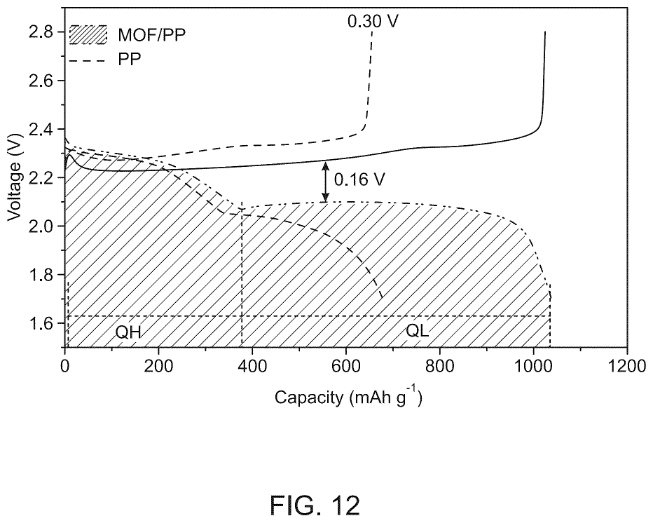

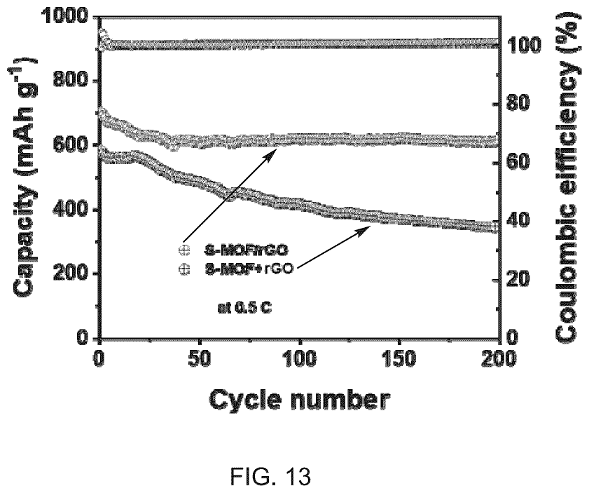

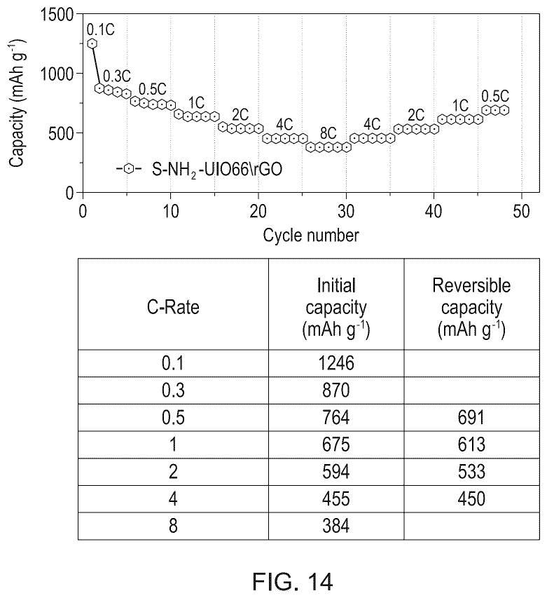

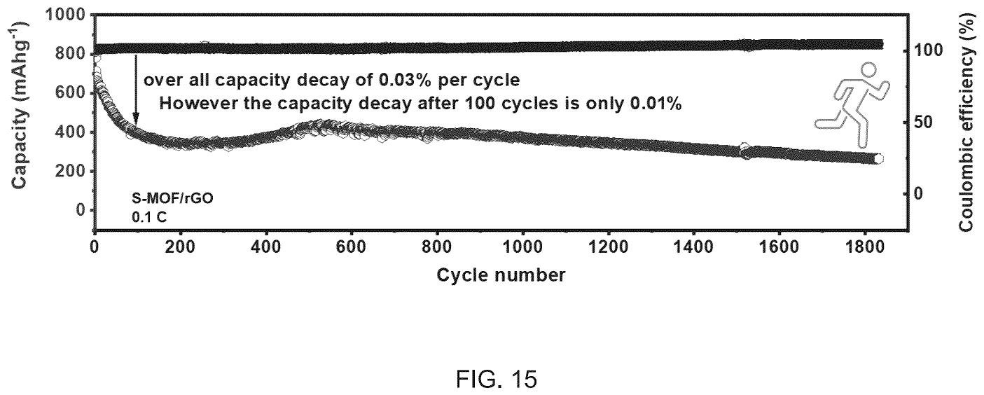

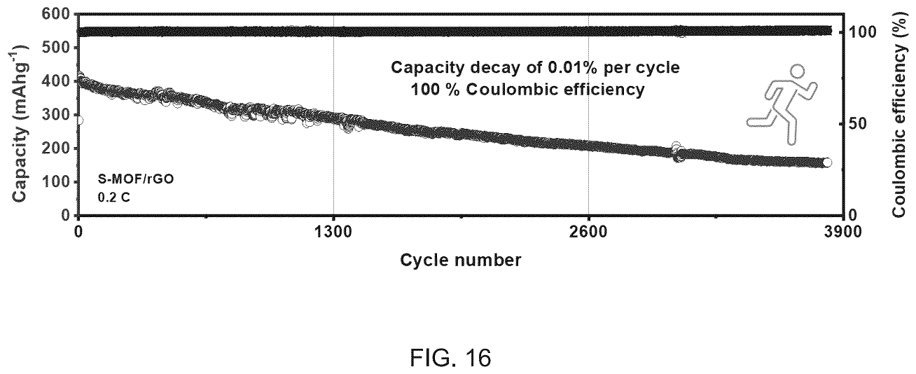

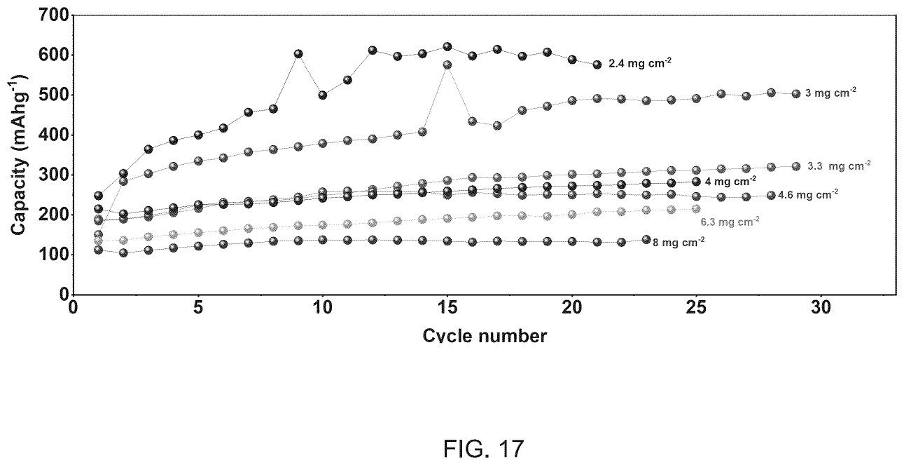

FIG. 12 shows the Electrochemical polarization studies for PP, and MOF/PP separators to further confirm the improved conversion of polysulfides. The discharge plateaus of Li—S with MOF/PP are flatter, along with a higher discharge and charge capacity. Moreover, Fe—ZIF-8/PP shows less voltage hysteresis (ΔE=0.16 V) compared with PP (ΔE=0.30 V). In the galvanostatic discharge curves, Q_{H} corresponds to the high discharge plateaus and Q_{L} corresponds to the low discharge plateaus for the conversion reaction of the polysulfides. The Li—S battery with MOF/PP displays the highest specific capacity for Q_{H} and Q_{L} compared with PP cell (Fe—ZIF-8/PP: Q_{H}: 378, Q_{L}: 658; PP: Q_{H}: 344, Q_{L}: 334 mAh g⁻¹). The high discharge capacity values for Q_{H} and Q_{L} confirm the electrocatalytic conversion of the polysulfides improved the utilization of active material.

### Example 2—Synthesis of MOF@rGO

The MOF@rGO as a sulphur host was synthesized by the following procedure. Dry GO powder (20 mg) was dispersed in 20 mL of DMF and subject to ultrasonic treatment for 3 hours to exfoliate the GO nanosheets and obtain a stable dispersion. Then, ZrCl₄ was added to the GO dispersion.

0.343 mmol ZrCl₄ was added to 20 mL of the GO dispersion. In this stage of the process, metal ions coordinate to the graphene oxide via the heterogeneous nucleation sites on the graphene oxide surface provided by the oxygen atoms. This solution was then treated in a bath sonicator (VWR Ultrasonic Cleaner) for 30 minutes. Then, x times 0.343 mmol 2-aminoteraphtahlic acid (where x=1, 1.5 and 2) and y μL (where y=20, 100 and 200) deionized H₂O was added to the solution under stirring. The water concentration and molar ligand-to-metal ratios were tested as tuning agents to control the MOF particle size.

The as-prepared solution was then transferred to a 125 mL Teflon-lined steel autoclave and treated at 120° C. in an oven (Termaks TS8024 Lab Drying Convection Oven) for 12 hours. This process causes the GO to be reduced to rGO. To remove the pristine MOF particles (unbound to the rGO) and purify the MOF@rGO, the sample was collected by centrifuge. The powder was redispersed in deionized water in the bath sonicator for half an hour before being transformed into centrifuged tubes. In between rounds, the supernatant was decanted and replaced with fresh deionized water 8 times for 10 minutes each time. The purified sample was then dried in a vacuum oven for 24 hours at 60° C.

### Sulphur Loading (S—NH₂—UiO66/rGO)

After drying, sulfur was loaded into MOF@rGO by a melt diffusion method. By using this method elemental sulfur can melt and then be infused into the MOF as it can pass through the pore windows in the MOF in its elemental form and be retained there. Typically, different amounts of as-synthesized MOF@rGO and sulfur were ground into a fine powder. Then, the mixture was transferred into an autoclave and heated in an oven at 155° C. for 12 h. Sulfur loaded into MOF@rGO was collected at room temperature and further ground into a fine powder and labeled as S-MOF@rGO.

In detail, sulfur loading into MOF@rGO was performed inside a closed system. Sulfur powder and MOF@rGO were thoroughly mixed by grinding and then sealed in a glass vial. The glass vial was then transferred inside the autoclave and heated at 155° C. for 12 h using vacuum oven.

### Example 3

The protocol above was repeated except that Cr was used instead of Zr. For Cr metal experiments: 0.5 mmol Cr(III)(NO₃)₃·H₂O was used along with 0.5 mmol of benzene-1,4-dicarboxylic acid, and x mL glacial acetic acid (where x=0.290, 0.435, and 0.625).

### Comparative Example 1: S-MOF+rGO Mixture

For S-MOF+rGO cathode: MOF particles were synthesized first by using the above-mentioned method without the addition of rGO. After the synthesis of MOF particles, rGO and MOF particles were mixed physically by using a piston and mortar and labeled as MOF+rGO. Sulphur was loaded into MOF+rGO by a melt diffusion method and labeled as S-MOF+rGO.

### Example 4

An electrochemical cell for Li—S battery was prepared using the S-MOF@rGO loaded with 75 wt % S based on the weight of S-MOF@rGO. The MOF@rGO used in the testing was based on the use of 0.257 mmol ZrCl₄ in 20 mL of 1 mg/mL GO in DMF, reacted with 0.386 mmol 2-aminoterephthalic acid as ligand.

The electrochemical cell has a Li anode, a cathode comprising S-MOF@rGO, Celgard separator, and liquid electrolyte.

The cathode slurry was prepared by mixing the S-MOF@rGO, Super P, and polyvinylidene fluoride binder (75:15:10 in weight ratio) in N-methyl-2-pyrrolidone solvent and ball milled in a sealed Teflon jar for about 60 minutes. The obtained slurry was cast onto an aluminum foil and dried at 60° C. overnight. After drying, cathodes were punched into a round shape with a diameter of 12 mm. The areal sulfur loading was 0.5-5 mg cm⁻².

CR-2032-coin cells were assembled using a lithium metal anode, Celgard 2400 separator, S-MOF@rGO cathode, and electrolyte in an Ar-filled glove box. This is illustrated in FIG. 1a. The electrolyte was composed of 1M lithium bis(trifluoromethanesulphonyl)imide in 1:1 (v/v) 1,3-dioxolane/1,2-dimethoxyethane with lithium nitrate additive. The electrolyte to sulfur ratio was 5-50 μL/mg of S. The charge/discharge voltage range was 1.6-2.8 V. The rate performance was also tested by varying the current density from 0.1 C to 8 C (1 C=1675 mA g⁻¹) using a Landt testing system at ambient temperature. Cyclic performance was measured by using Biologic at different scan rates.

Li—S battery with S-MOF@rGO exhibits 700 mAh g⁻¹ discharge capacity ending with 615 mAh g⁻¹ after 200 cycles with capacity decay of per cycle only 0.06% and the Coulombic efficiency is ˜100%.

In contrast, the S-MOF+rGO cathode shows low initial capacity of 583 mAh g⁻¹ and endings with 343 mAh g⁻¹ with a capacity decay of 0.20% per cycle at 0.5 C.

What is claimed is:

1. A lithium sulphur battery, comprising:
(i) a Li anode,
(ii) a separator between the anode and cathode,
(iii) a Li-containing electrolyte; and
(iv) a sulphur-containing cathode;
wherein the separator comprises a porous substrate carrying a metal-organic framework comprising at least two different metal ions one of which is an iron ion.

2. The lithium sulphur battery of claim 1, wherein the metal-organic framework is non-carbonised.

3. The lithium-sulfur battery of claim 1, wherein the porous substrate of the separator is a polypropylene or polyethylene, preferably polypropylene.

4. The lithium-sulfur battery of claim 1, wherein the porous substrate of the separator is a porous polypropylene film or non-woven or melt-blown porous polypropylene fabric.

5. The lithium-sulfur battery of claim 1, wherein the substrate in the separator has a thickness of 10 to 50 μm.

6. The lithium-sulfur battery of claim 1, wherein the metal-organic framework is a zeolitic imidazolate framework, e.g. ZIF-1-20, preferably ZIF-8.

7. The lithium-sulfur battery of claim 1, wherein the metal-organic framework comprises at least two 1^{st} row transition metal ions.

8. The lithium-sulfur battery of claim 1, wherein the metal-organic framework comprises Fe ions and one of Co, Zn, Zr, Mn, Fe and Cr ions.

9. The lithium-sulfur battery of claim 1, wherein the metal-organic framework comprises Zn ions and Fe ions, e.g. Zn ions and Fe(II) ions.

10. The lithium-sulfur battery of claim 1, wherein the molar ratio of the metal ions is 20:1 to 1:1, especially Zn:Fe of 20:1 to 1:1.

11. The lithium-sulfur battery of claim 1, wherein the metal-organic framework comprises Cr and Fe ions, such as Cr and Fe(II) ions.

12. The lithium-sulfur battery of claim 1, wherein the molar ratio of the metal ions is 20:1 to 1:1, especially Cr:Fe of 20:1 to 1:1.

13. The lithium-sulfur battery of claim 1, wherein the bimetallic MOF forms a layer 1.0 to 15.0 microns thick on the substrate, such as 1.0 to 5.0 microns.

14. The lithium-sulfur battery of claim 1, wherein the cathode comprises a reduced graphene oxide sheet chemically bound via the basal plane of said reduced graphene oxide to a metal-organic framework via an oxygen-metal linker, said metal-organic framework being infused with sulphur to form a structure S-MOF@rGO wherein the weight of sulphur based on the weight of the S-MOF@GO is 50% to 90%, e.g. wherein the MOF is NH₂-UiO-66(Zr) or MIL101(Cr).

15. A separator suitable for use in a battery, such as a Li—S battery, comprising a porous substrate carrying a metal-organic framework comprising at least two different metal ions one of which is an iron ion.

16. The separator of claim 15, wherein the pore size of the MOF is in the range of 2 to 20 Å.

17. The separator of claim 15, wherein the MOF is a zeolitic imidazolate framework, e.g. ZIF-1-20, preferably ZIF-8.

18. The separator of claim 15, wherein one of said metal ions acts as an electrocatalyst for adsorption and conversion of polysulfides.

19. The separator of claim 15, wherein the zeolitic imidazolate framework comprises Zn and Fe ions or Cr and Fe ions such as Zn/Cr and Fe (II) ions.

20. The separator of claim 15, which does not undergo thermal shrinkage when subject to heating up to 150° C.

21. The separator of claim 15, wherein the molar ratio of the metal ions is 20:1 to 1:1, especially Cr or Zn:Fe of 20:1 to 1:1.

22. A process for the preparation of a separator of claim 15, comprising;
1) dissolving two metal salts one of which is an iron salt in a solvent in the presence of an imidazole type ligand or tri or dicarboxylic acids such as 1,4-benzenedicarboxylic acid and mixing in order to allow the formation of a precipitate which comprises a metal organic framework comprising at least two different metal ions one of which is an iron ion;
2) separating the precipitate and forming a slurry therewith and coating the same onto a porous substrate.

23. The process of claim 22, wherein step 1) is effected at a temperature of 50° C. or below.

24. A lithium sulphur battery, comprising:
(i) a Li anode,
(ii) a separator between the anode and cathode,
(iii) a Li-containing electrolyte; and
(iv) a sulphur-containing cathode;
wherein the separator comprises a porous substrate carrying a metal-organic framework comprising at least two different metal ions, wherein said metal-organic framework is a zeolitic imidazolate framework.

25. A process for the preparation of a cathode material for a Li—S battery, said process comprising:
(i) nucleating metal ions on a graphene oxide or reduced graphene oxide sheet such that the metal ions are chemically bound to the basal plane of the graphene oxide or reduced graphene oxide sheet;
(ii) subsequently, growing a metal-organic framework comprising said chemically bound metal ions by adding to the product of step (i) a polyfunctional ligand and optionally heating the resulting mixture to a temperature of at least 20° C., such as 100 to 250° C. so as to form a metal organic framework bound to a reduced graphene oxide sheet (MOF@rGO);
(iii) infusing elemental sulphur into the metal organic framework to form S-MOF@rGO such that the weight of sulphur based on the weight of the S-MOF@rGO is 50% to 90%.

26. A process of claim 25, wherein the MOF is formed using a polyfunctional organic ligand such as a polycarboxylic ligand.

27. A process of claim 25, wherein the MOF is prepared using a tri or dicarboxylic acid such as 4-benzenedicarboxylic acid, 1,3,5-benzenetricarboxylic acid or 2-aminoteraphthalic acid or salts thereof.

28. A process of claim 25, wherein the metal ion used is a 1^{st} row transition metal.

29. A process of claim 25, wherein the metal ion used is Zr, Co, Zn, Cr, or Cu, especially Zr or Cr.

30. A process of claim 25, wherein the graphene oxide is reduced during step (ii), e.g. by heating.

31. The process of claim 25, wherein the amount of sulphur present in the S-MOF@rGO material is 60 to 90 wt %.

32. The process of claim 25, wherein the amount of MOF in the MOF@rGO is 60 to 98 wt %.

33. The process of claim 25, wherein step (i) takes place in the absence of urea.

34. The process of claim 25, wherein the graphene oxide in step (i) is obtained by exfoliating graphene oxide dispersed in an organic solvent by ultrasonication in the absence of sulphuric acid.

35. The process of claim 25, wherein the graphene oxide in step (i) is obtained by exfoliating graphene oxide dispersed in an organic solvent by ultrasonication at a temperature less than 60° C., such as room temperature.

36. The process of claim 25, wherein graphene oxide is used in step (i) and wherein said graphene oxide is reduced in step (ii).

37. A cathode for a Li—S battery comprising a reduced graphene oxide sheet chemically bound via the basal plane of said reduced graphene oxide to a metal-organic framework via an oxygen-metal linker, said metal organic framework being infused with sulphur to form a structure S-MOF@rGO wherein the weight of sulphur based on the weight of the S-MOF@GO is 50% to 90%.

38. The cathode of claim 37, wherein the MOF is NH₂-UiO-66(Zr) or MIL101(Cr).

39. The lithium sulphur battery of claim 37, comprising:
(i) a Li anode,
(ii) a separator between the anode and cathode,
(iii) a Li containing electrolyte; and
(iv) a cathode.

40. The lithium sulphur battery of claim 39, wherein the separator comprises a bimetallic MOF.

41. The Li—S battery of claim 39, wherein having a real sulphur loading of 0.1 to 9 mg cm⁻².

42. The Li—S battery of claim 39, wherein high areal sulphur loading of 0.1 to 9 mg cm⁻² was used in different volumes of the electrolytes 5 to 50 μL.

43. The Li—S battery of claim 39, wherein different Electrolytes to Sulfur ratio was used (E:S=5 to 50 μL:mgs).
